(19) United States
(12) Patent Application Publication
(10) Pub. No.: US 2012/0136762 A1
(43) Pub. Date: May 31, 2012

(54) Systems, Methods, and Media for Lifestyle Management

(76) Inventor: Stefan Wissenbach, Meriden (GB)

(21) Appl. No.: 13/304,204

(22) Filed: Nov. 23, 2011

Related U.S. Application Data
(60) Provisional application No. 61/416,913, filed on Nov. 24, 2010.
(60) Provisional application No. 61/536,041, filed on Sep. 18, 2011.
(60) Provisional application No. 61/538,153, filed on Sep. 23, 2011.

(51) Int. Cl. G06Q 40/00

(52) U.S. Cl. 705/30

(57) ABSTRACT

Systems and methods for lifestyle management are provided. In some embodiments, systems for lifestyle management are provided, the systems comprising: at least one hardware processor that: receives a work-optional age selection from a user; receives a plurality of lifestyle choice settings; based on the plurality of lifestyle choice settings, presents prompts to the user to make a selection of a desired lifestyle for each of a plurality of lifestyle categories; receives from the user a plurality of desired lifestyle selections in response to the prompts; and based on the plurality of desired lifestyle selections, presents a currency amount of assets needed for the user to live a lifestyle consistent with the plurality of desired lifestyle selections for a period of the life of the user.

### CROSS-REFERENCE TO RELATED APPLICATIONS

The present application claims the benefit of U.S. Provisional Patent Applications Nos. 61/416,913, filed Nov. 24, 2010, 61/536,041, filed Sep. 18, 2011, and 61/538,153, filed Sep. 23, 2011, each of which is hereby incorporated by reference herein in its entirety.

### TECHNICAL FIELD

Systems, methods, and media for lifestyle management are provided.

### BACKGROUND

Visualisation and planning are key steps for a user to achieve his/her goals and live a focused and fulfilled life. A small percentage of the global population may find that these attributes come naturally. For the majority of the population, such attributes do not come naturally, resulting in ineffectiveness and/or inefficiency when it comes to decision-making. Such individuals may often be paralysed in their ability to make the right decisions. Accordingly, mechanisms to help users in lifestyle management are desirable.

### SUMMARY

Systems, methods, and media for lifestyle management are provided. In some embodiments, systems for lifestyle management are provided, the systems comprising: at least one hardware processor that: receives a work-optional age selection from a user; receives a plurality of lifestyle choice settings; based on the plurality of lifestyle choice settings, presents prompts to the user to make a selection of a desired lifestyle for each of a plurality of lifestyle categories; receives from the user a plurality of desired lifestyle selections in response to the prompts; and based on the plurality of desired lifestyle selections, presents a currency amount of assets needed for the user to live a lifestyle consistent with the plurality of desired lifestyle selections for a period of the life of the user.

In some embodiments, methods for lifestyle management are provided, the methods comprising: receiving, at least one hardware processor, a work-optional age selection from a user; receiving, at least one hardware processor, a plurality of lifestyle choice settings; based on the plurality of lifestyle choice settings, causing to be presented, by at least one hardware processor, prompts to the user to make a selection of a desired lifestyle for each of a plurality of lifestyle categories; receiving, at least one hardware processor, from the user a plurality of desired lifestyle selections in response to the prompts; and based on the plurality of desired lifestyle selections, causing to be presented, by at least one hardware processor, a currency amount of assets needed for the user to live a lifestyle consistent with the plurality of desired lifestyle selections for a period of the life of the user.

In some embodiments, non-transitory computer-readable media containing computer-executable instructions that, when executed by a processor, cause the processor to perform a method for lifestyle management are provided, the method comprising: receiving, at least one hardware processor, a work-optional age selection from a user; receiving, at least one hardware processor, a plurality of lifestyle choice settings; based on the plurality of lifestyle choice settings, causing to be presented, by at least one hardware processor, prompts to the user to make a selection of a desired lifestyle for each of a plurality of lifestyle categories; receiving, at least one hardware processor, from the user a plurality of desired lifestyle selections in response to the prompts; and based on the plurality of desired lifestyle selections, causing to be presented, by at least one hardware processor, a currency amount of assets needed for the user to live a lifestyle consistent with the plurality of desired lifestyle selections for a period of the life of the user.

### BRIEF DESCRIPTION OF THE DRAWINGS

FIG. 1A is an example of a user interface for introducing the user to the mechanisms described herein and collecting preliminary data in accordance with some embodiments.

FIG. 1B is an example of a user interface for collecting data on high-level lifestyle choices in accordance with some embodiments.

FIG. 2 is an example of a user interface for introducing a user to the process of designing a lifestyle in accordance with some embodiments.

FIG. 3 is an example of a user interface for selecting a desired housing expense in accordance with some embodiments.

FIG. 4 is an example of a user interface for selecting a desired transportation expense in accordance with some embodiments.

FIG. 5 is an example of a user interface for selecting a desired hobby expense in accordance with some embodiments.

FIG. 6 is an example of a user interface for selecting a desired vacation expense in accordance with some embodiments.

FIG. 7 is an example of a user interface for selecting a desired charity expense in accordance with some embodiments.

FIG. 8 is an example of a user interface for selecting a desired lifestyle expense in accordance with some embodiments.

FIG. 9 is an example of a user interface for selecting a desired legacy expense in accordance with some embodiments.

FIG. 10 is an example of a user interface for indicated amounts owed and in assets in accordance with some embodiments.

FIG. 11 is an example of a user interface for displaying a Magic Number in accordance with some embodiments.

FIGS. 12 and 13-16 are examples of a user interface for a dashboard in accordance with some embodiments.

FIG. 12b is an example of another user interface for a dashboard in accordance with some embodiments.

FIGS. 17-20 are examples of user interfaces for a vision board in accordance with some embodiments.

FIGS. 21-22 are examples of user interfaces for tracking habits in accordance with some embodiments.

FIGS. 23-27 are examples of user interfaces for tracking goals in accordance with some embodiments.

FIGS. 28-35 are other examples of user interfaces for tracking goals in accordance with some embodiments.

FIGS. 36-38 are examples of user interfaces for creating a mission statement in accordance with some embodiments.

FIGS. 39-42 are examples of user interfaces for designing a lifestyle using a vision board in accordance with some embodiments.

FIG. 43 is an example of a user interface for an inspiration lounge in accordance with some embodiments.

FIG. 44 is an example of hardware that can be used to implement some embodiments.

### DETAILED DESCRIPTION

Systems, methods, and media for lifestyle management are provided.

In accordance with some embodiment, such systems, methods, and media can provide mechanisms for managing one's lifestyle. Such mechanisms can be implemented in an interactive digital environment, such as on an Internet Web page, a mobile device “App” (such as a mobile phone application or “App” or a tablet computer application or “App”), an interactive television application, an Internet appliance, etc.

In accordance with some embodiments, a “Magic Number” can be determined and presented to a user. A Magic Number may indicate a total cost of a lifestyle desired by a user. This Magic Number may apply to a lifestyle desired when the user has reached a work-is-optional age (or Magic Number age). That is, when the user has the Magic Number amount of money saved (or otherwise available), work becomes an option for the user. Thereafter, the user can live the desired lifestyle without working (unless the user wants to work).

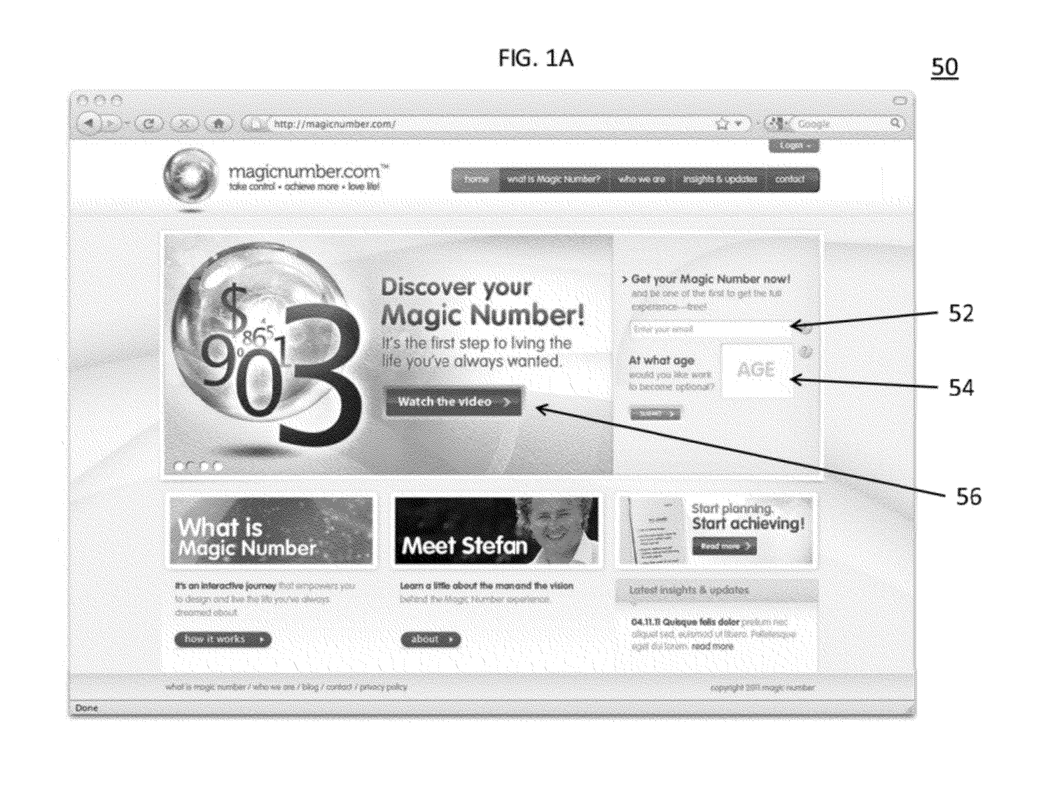

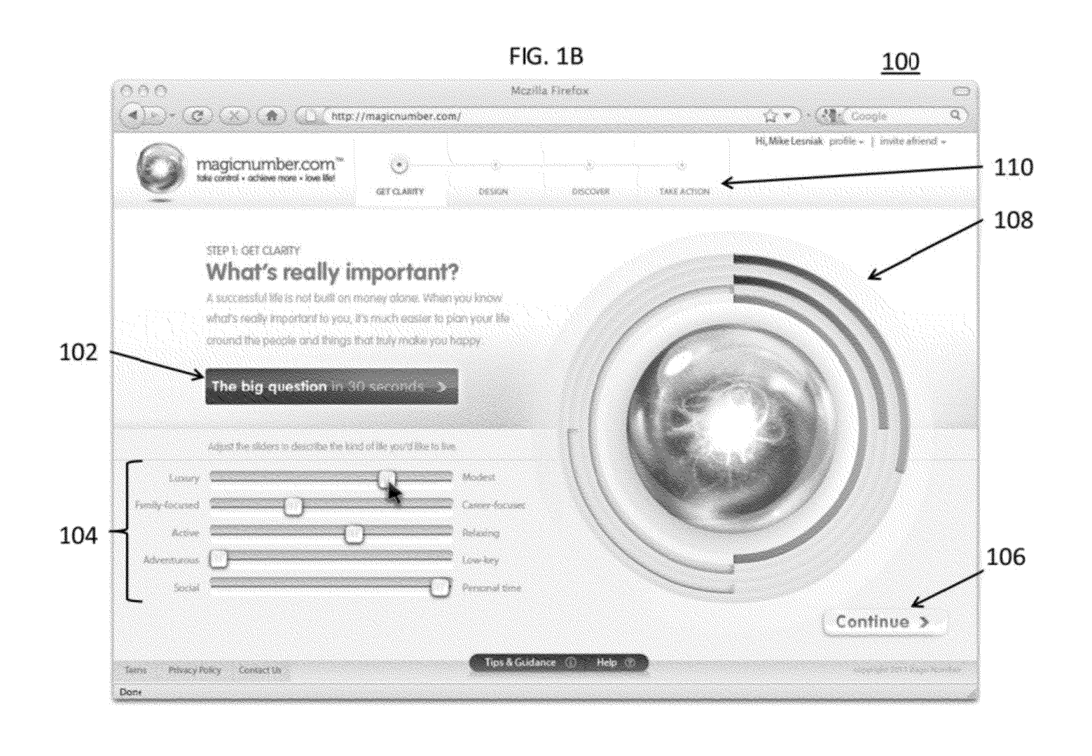

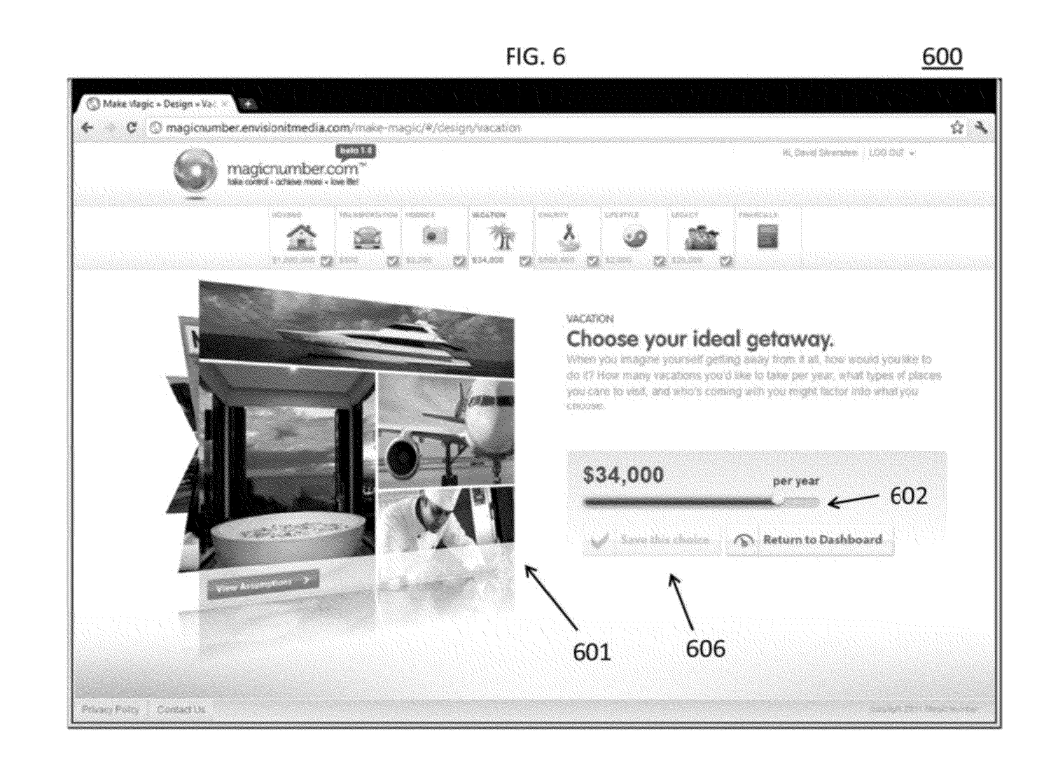

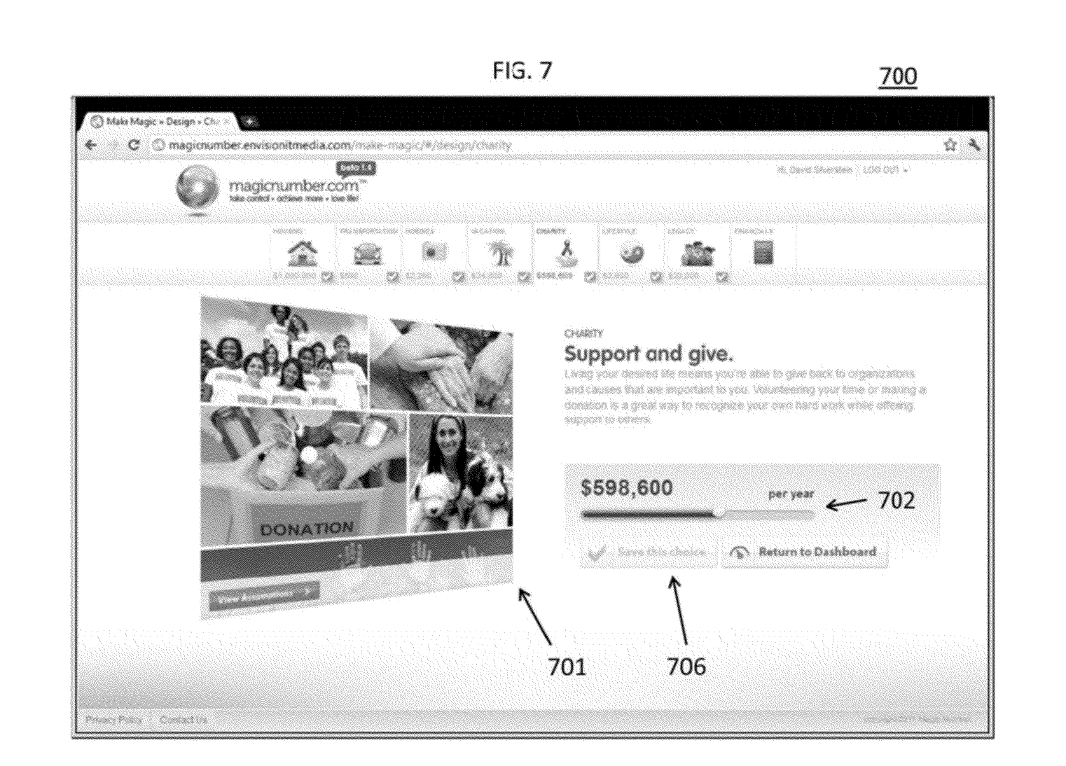

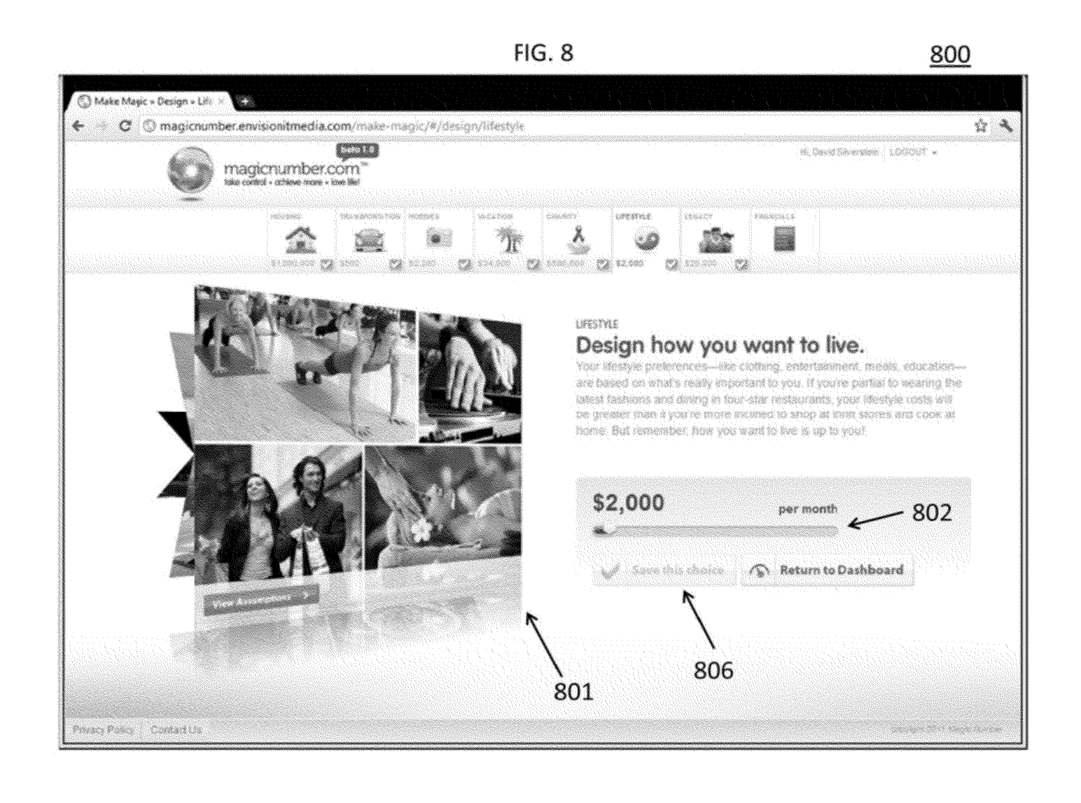

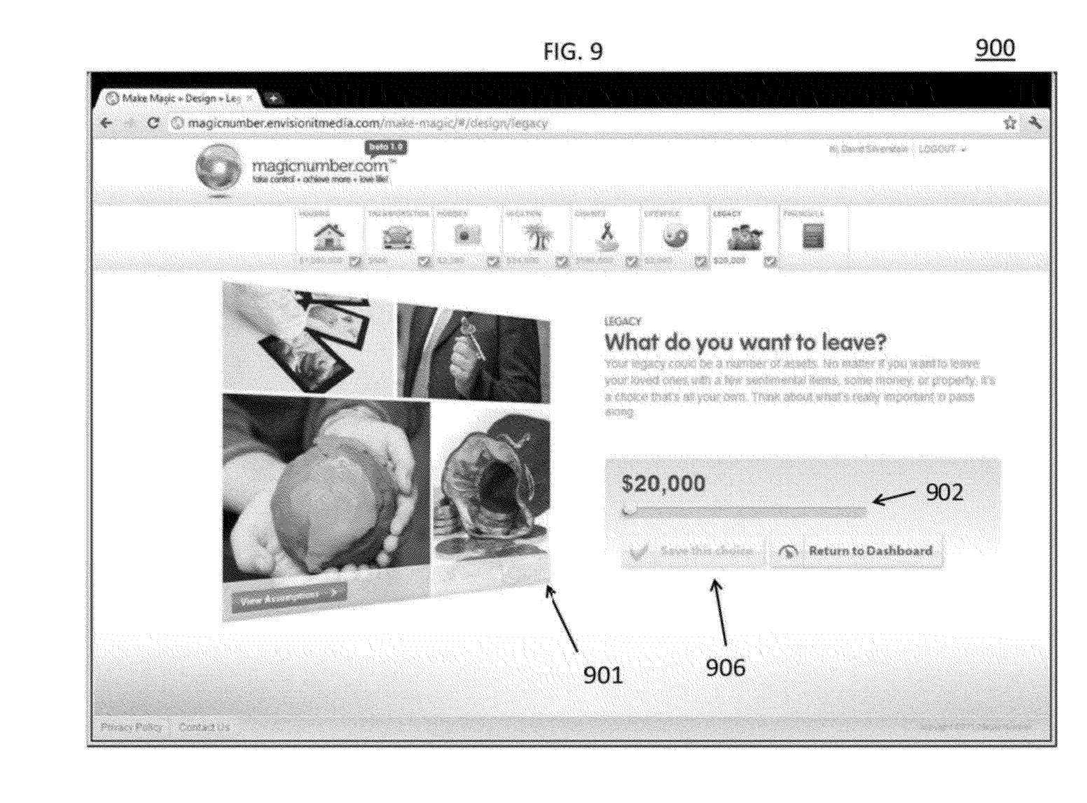

FIGS. 1-10 illustrate an example of an interview process that can be used to help a user determine his or her Magic Number.

As shown in FIG. 1A, a user can first be introduced to the concept of a Magic Number using a user interface 50. This introduction can include any suitable content. For example, this introduction can provide a demonstration and virtual tour of a Web site based on mechanisms as described herein and its benefits. This introduction can be made in any suitable form. For example, in some embodiments, the introduction can be made by presenting a video presentation to the user. Such a video presentation can be initiated by the user clicking on a button 56 in the interface. The video presentation can include a video of a person, the video can be animated, etc. In some embodiments, separate text and/or audio can additionally or alternatively be presented to the user to introduce the concept of a Magic Number, such as via a link to a blog.

In some embodiments, an introductory interface, such as interface 50, can additionally or alternatively include one or more introductory testimonials of the benefits of using mechanisms as described herein.

In some embodiments, an introductory interface, such as interface 50, can prompt the user to enter an age at which the user would like work to become optional using a prompt 54.

In some embodiments, an introductory interface, such as interface 50, can include a registration mechanism through which the user can indicate his or her email address using field 52, and, additionally or alternatively, name, street address, date of birth, postal code, country, and/or any other suitable data.

In some embodiments, a user can next indicate what type of life the user would like to live based on multiple criteria. This indication can be made in any suitable manner. For example, as illustrated in interface 100 of FIG. 1B, multiple sliders 104 can be provided to enable a user to select the level of luxuriousness he or she would like to live in (e.g., on a scale from “Luxury” to “Modest”), the level of family focus in the user's life (e.g., on a scale from “Family focused” to “Career focused”), the level of activity in the user's life (e.g., on a scale from “Active” to “Relaxing”), the level of adventure in the user's life (e.g., on a scale from “Adventurous” to “Low key”), the level of social interaction in the user's life (e.g., on a scale from “Social” to “Personal time”), and/or any other suitable criteria or criterion.

In some embodiments, as the user moves the sliders between the extremes, colored bands surrounding a Magic Number orb 108 can move to reflect their choices, thereby giving the user an individualized orb based on his or her selections.

In some embodiments, a progress bar 110 can be provided on user interface 100 and other user interfaces described below to show the user how far along through the interview process the user is.

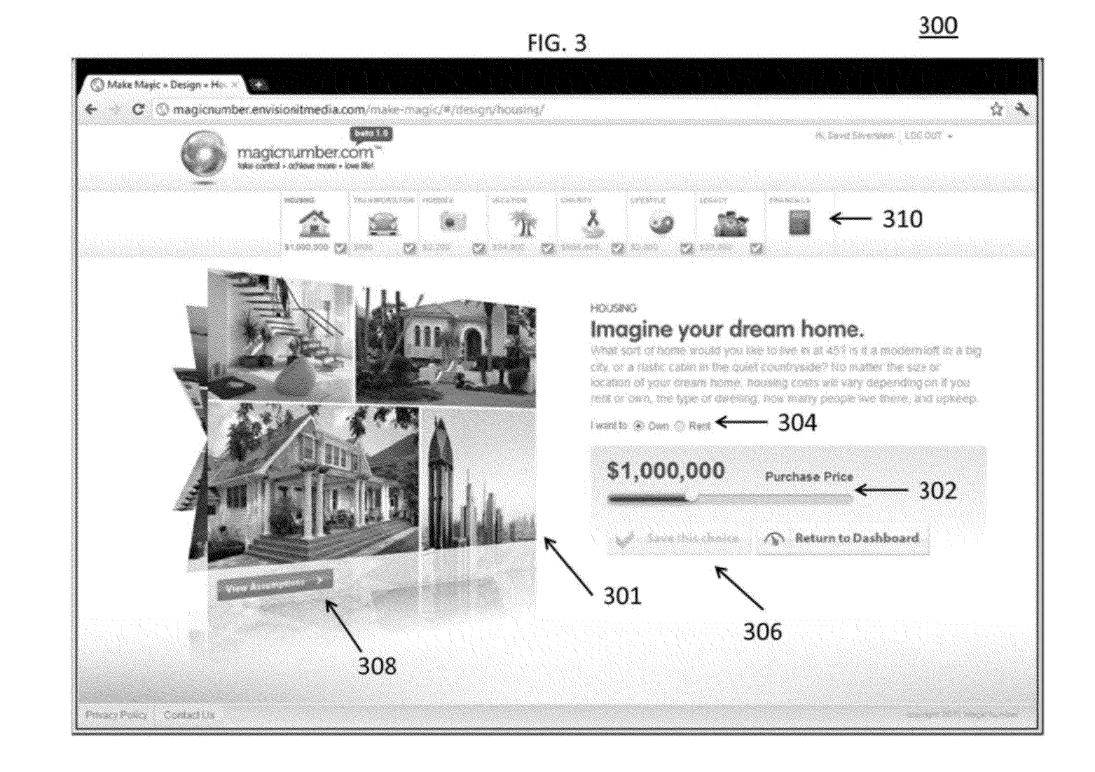

Next, after clicking on continue button 106 in interface 100, a user can provide further, more specific details on the life the user would like to live using the interfaces described in FIGS. 3-10.

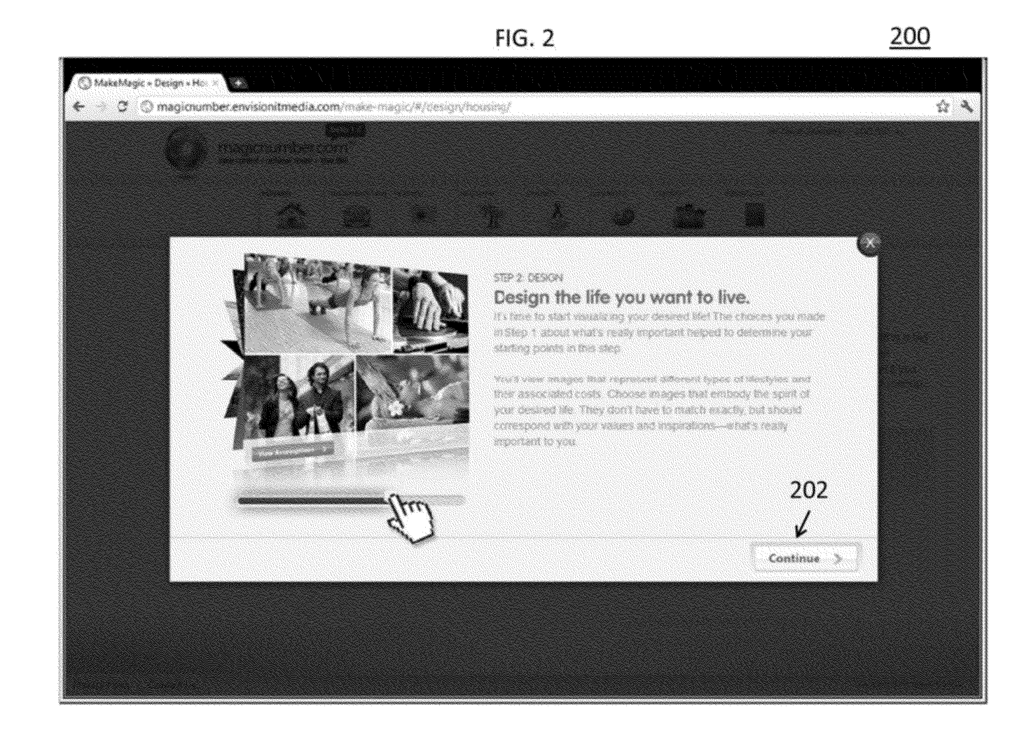

As shown in FIG. 2, an interface 200 can provide a user with a quick introduction to explain how the user can provide further, more specific details on the life the user would like to live using the interfaces described in FIGS. 3-10, after which a user can proceed to interface 300 of FIG. 3 by clicking on button 202.

As shown below in connection with FIGS. 3-10, the user can then indicate the level of and/or manner in which he or she would like to make expenditures in multiple “life” categories. Any suitable categories and any suitable number of categories can be used in some embodiments. For example, the user can be prompted to make indications for the following seven categories:

1. Housing (e.g., how much the user would like to spend on housing);
2. Transportation (e.g., how much the user would like to spend on car(s), boat(s), plane(s), and/or motorcycle(s));
3. Hobbies (e.g., how much the user would like to spend on hobbies);
4. Vacations (e.g., how much the user would like to spend on vacations);
5. Charity (e.g., how much the user would like to give to charity);
6. Lifestyle (e.g., how much the user would like to spend on eating in, eating out, healthcare, entertainment, family, gifts, etc.); and
7. Legacy (e.g., how much money the user would like to leave to his/her estate).

For some categories, the level of expenditure can be monthly, for others the level of expenditure can be made on an annual basis, for others the level of expenditure, and for still other the level of expenditure can be made at any suitable frequency for any suitable number of times.

Turning to FIG. 3, an example of an interface 300 for determining a level of expenditure on housing in accordance with some embodiments is shown. As illustrated, the user can be presented with a montage of images 301 corresponding to a level of expenditure on a slider 302. As the user moves slider 302, the montage of images 301 can change (e.g., like the flipping of a spinning Roladex) to correspond to the changed dollar amounts shown next to slider 302. This can help the user to associate visually with the level of expenditure he or she has selected. For example, the most expensive end of the housing category may include a mansion, and the least expensive end of the housing category may include a studio apartment.

In some embodiments, the user can additionally specify whether the level of expenditure is for owning or renting housing radio buttons 304.

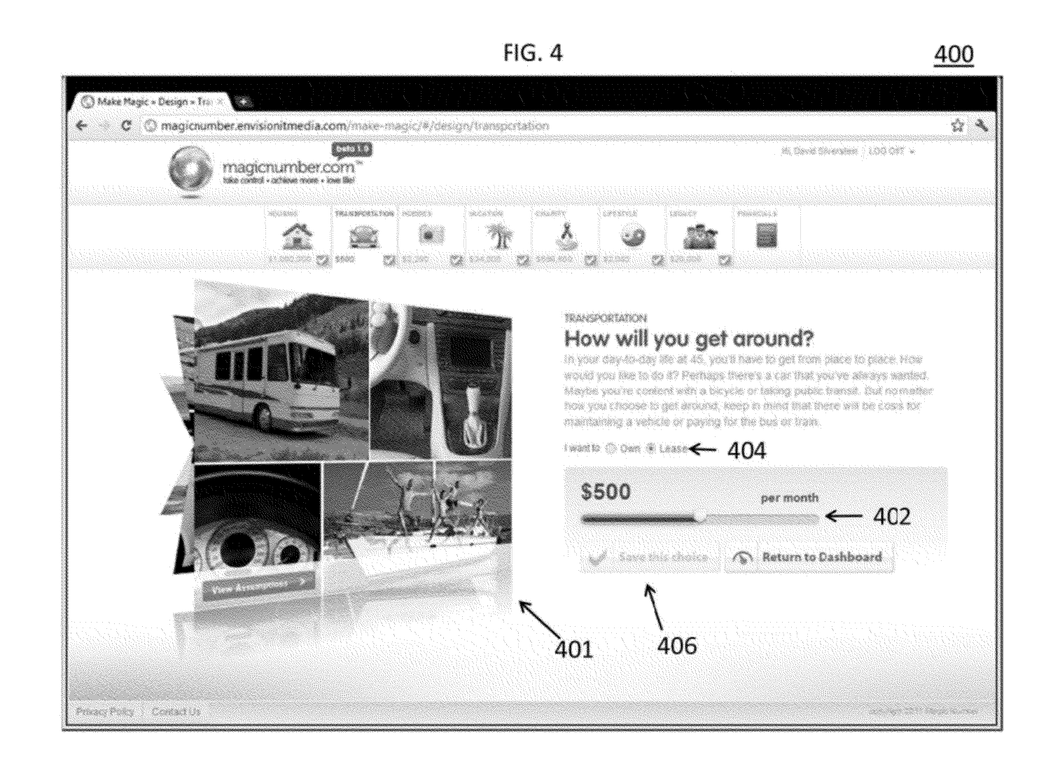

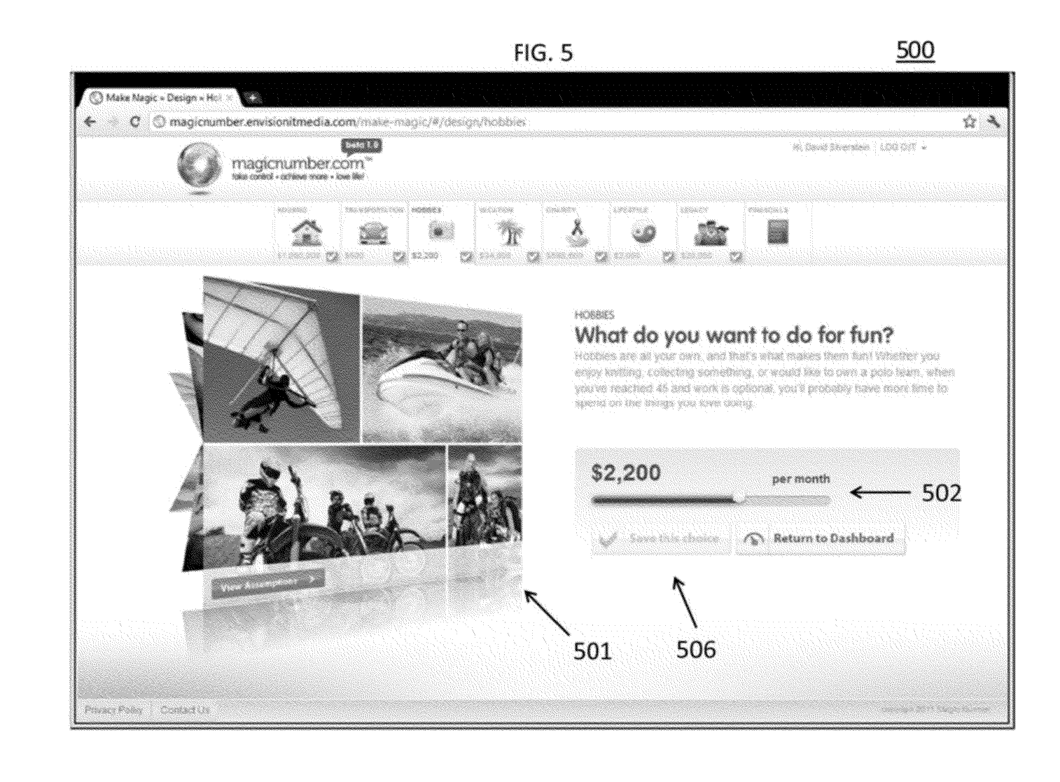

Similarly, as shown in FIGS. 4-9, examples of interfaces 400, 500, 600, 700, 800, and 900 for determining levels of expenditure on transportation, hobbies, vacation, charity, lifestyle, and legacy, respectively, in accordance with some embodiments are shown. As illustrated, the user can be presented with montages of images 401, 501, 601, 701, 801, and 901 corresponding to levels of expenditure on sliders 402, 502, 602, 702, 802, and 902, respectively. As the user moves sliders 402, 502, 602, 702, 802, and 902, the montage of images 401, 501, 601, 701, 801, and 901, respectively, can change (e.g., like the flipping of a spinning Roladex) to correspond to the changed dollar amounts next to the sliders. With respect to interface 400, in some embodiments, the user can additionally specify whether the level of expenditure is for buying or leasing a vehicle using radio buttons 404.

In some embodiments, the default position of slider 302, 402, 502, 602, 702, 802, and 902 can be determined by the position of one or more of sliders 104 of FIG. 1. For example, if the user set the Luxury-Modest slider in sliders 104 at its “Luxury” end, slider 302 and the corresponding montage of images 301 can automatically reflect that choice and provide images of a luxury lifestyle.

In some embodiments, one or more of the sliders can be assigned a range of values based on pre-set assumptions of ranges specific to the corresponding category. Any suitable ranges and any suitable number of increments in the ranges can be used in some embodiments.

As described above, in some embodiments, if a user moves a slider up to a certain point, doing so will trigger a change in the corresponding montage of images. If a user moves the slider to the most expensive extreme of the slider (e.g., the far right), a box (which can be referred to herein as a “free form box”) may appear and the user may input into this box his or her preferred monthly or annual amount for the slider category. For example, if the top end of the pre-set ranges is $20,000 per year and a user wishes to input $50,000, he/she may do so using the box that appears when the slider is moved to the extreme end. When at the extreme end, the images may remain the same as when just short of the extreme end, but the value chosen by the user may be used in the Magic Number calculation.

In some embodiments, each set of images for each category may have a view-assumptions button (e.g., such as view-assumptions button 308 of FIG. 3) which cause an explanation of the assumptions behind the imagery and costs to be displayed. In some embodiments, this may be done presenting the assumption data on top of or adjacent to each montage of images and rotating (e.g., in a Roladex fashion) the montage of images.

In some embodiments, the costs associated with each category (based on where the user places the corresponding slider) can be used to provide input data for the calculation of the Magic Number. In some embodiments, the user can override the slider selection by inputting his or her own number into a free-form box as described above.

In some embodiments, a user may be required to complete all or certain categories (e.g., property, transport and lifestyle) categories in order to have a Magic Number calculated.

In some embodiments, the user may be able to go back to previously set sliders and modify the corresponding setting by clicking on icons such as icons 310 in FIG. 3. A change to a slider setting may then change the Magic Number and a corresponding prompt may be displayed.

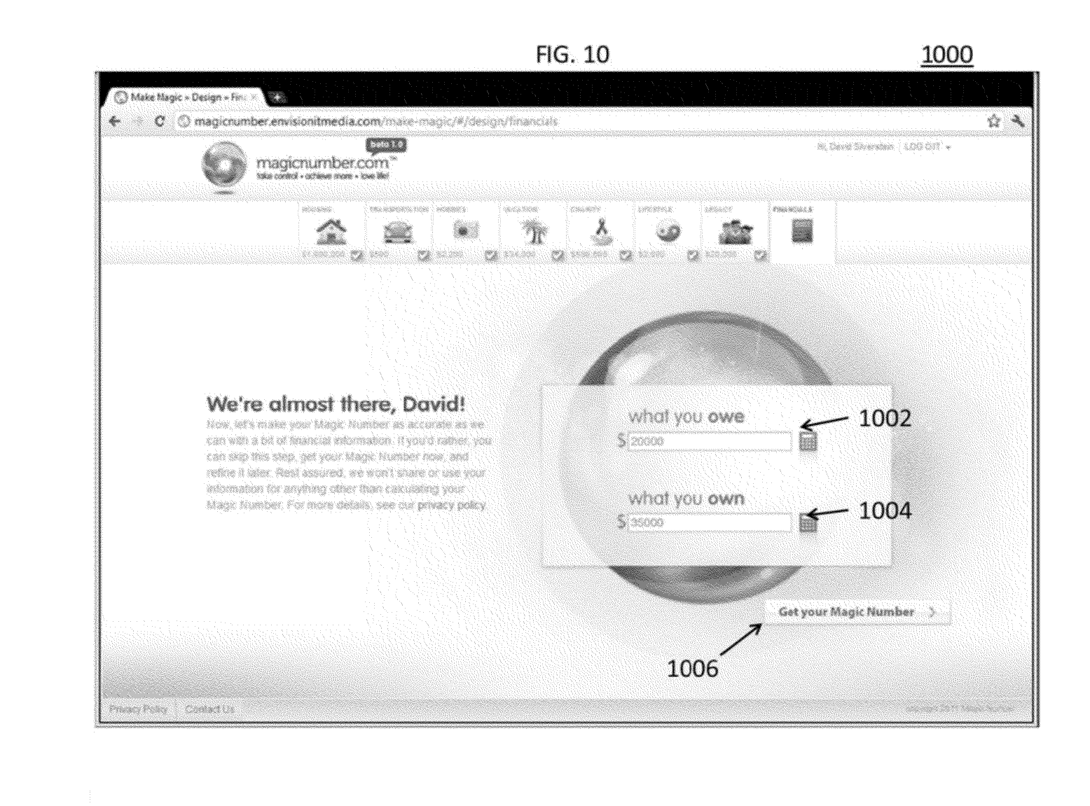

Once the user has made a selection on a slider 302, 402, 502, 602, 702, or 802, the user can proceed to the next interface 400, 500, 600, 700, 800, or 900, respectively, by clicking on “save this choice” button 306, 406, 506, 606, 706, or 806, respectively. When the user has made a selection on slider 902, the user can proceed to user interface 1000 of FIG. 10 by clicking on “save this choice” button 906.

As shown in FIG. 10, user interface 1000 can provide a mechanism through which the user can indicate what he or she owes 1002 (i.e., the user's liabilities) and what he or she owns 1004 (i.e., the user's assets).

In some embodiment, the user can skip entering an amount owed and/or an amount of assets. However, if these numbers are not entered, then the amount needed to increase the user's worth by per day/month/year to reach the user's Magic Number may not be accurate.

In some embodiments, a user may be able to open a window to add multiple items of assets and/or liabilities in order to calculate and amount of assets and/or liabilities.

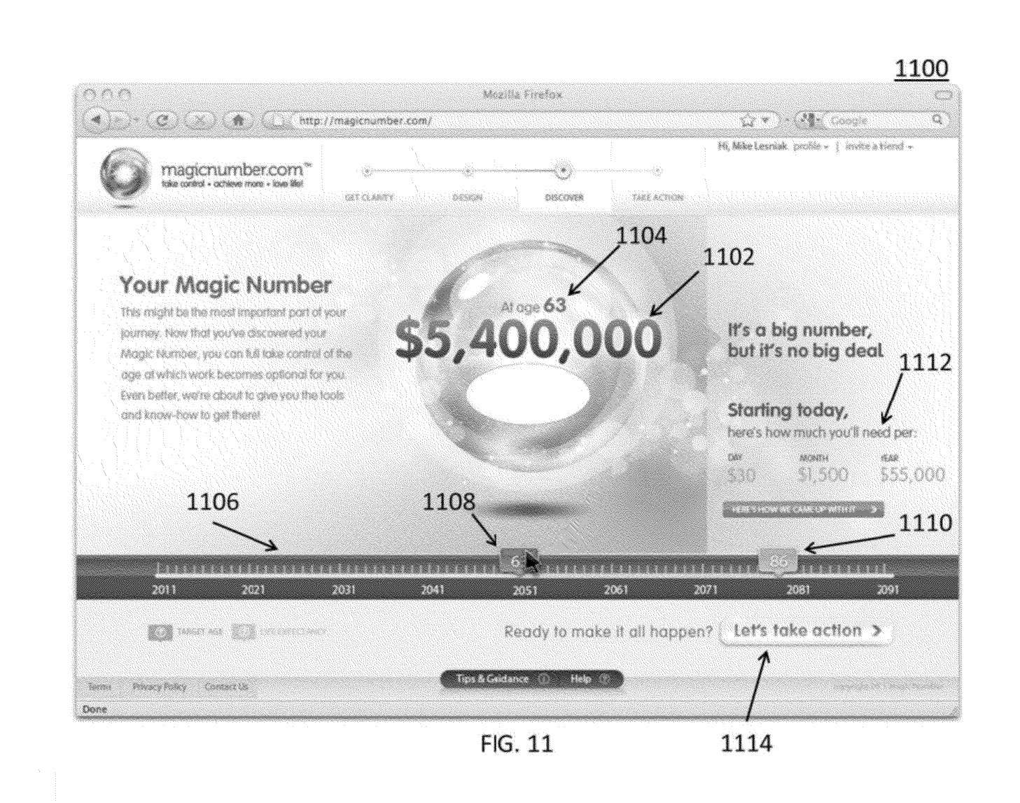

Once the interfaces of FIGS. 1-10 have been completed, the Magic Number 1102 can be calculated and displayed to the user as illustrated in example interface 1100 of FIG. 11. As shown, because the Magic Number is based on a selected age when work becomes optional, this age 1104 can also be displayed in interface 1100. As described above, the Magic Number is the amount of wealth that is predicted to enable the user to live the specified lifestyle for the rest of his/her life based on a given life expectancy and the selected Magic Number age (work-optional age). The Magic Number can be calculated as the amount of money needed at the work-optional age to pay for all costs until death and to leave the desired legacy, as well as certain assumptions such as inflation, property price index, asset growth rate, depreciation rates on vehicles, property and vehicle running costs, and/or any other suitable data.

As shown in FIG. 11, a slider bar 1106 can be provided that enables the user to change the work-optional age and the expected-death age using sliders 1108 and 1110, respectively. Life expectancy slider 1110 can be set at the default value for the user in his or her particular country based on the average life expectancy for men and women from mortality tables in some embodiments. Thus, the setting of slider 1110 can be determined by the user's selection of “male” or “female” at the point of registration. If the user moves work-option-age slider 1108 to the left (i.e., the user indicates that the point at which work becomes optional should be at an earlier age), then the user's Magic Number will increase and the new number will be displayed. If the user moves slider 1108 to the right, then the user's Magic Number will decrease.

As shown in area 1112, in some embodiments, wealth-improvement requirements needed to reach the Magic Number at the work-optional age can be presented. As shown, this wealth-improvement requirement can be indicated on a daily, monthly, and/or yearly basis.

In some embodiments, the assumptions used to calculate the Magic Number can be validated by an independent expert, data provider, etc. Assumptions may be tailored to each country as needed. A rationale may be provided explaining why and how the defaults/assumptions have been set or determined. The assumptions may be maintained and/or changed as needed based on prevailing market conditions. The assumptions can be reviewed quarterly, and or at any other suitable frequency (or from time to time) and changes made to them as required.

In some embodiments, a user can view the assumptions and change them. In the event that an assumption is changed by a user, the user may be given a warning to the effect that the user is using his/her own assumptions which have not been validated. In some embodiments, there may be maxima and minima on the changes allowed to ensure that valid data is used.

In some embodiments, an assumptions-based calculation may also be made for the running costs of certain categories such as property and transport. Such assumptions may be used to accurately reflect lifetime cash flows, although the user may not be able to account for such running costs (e.g., car maintenance, fuel, tax, insurance, etc.). A user may be allowed to view the assumptions underlying the calculation of such running costs and how the assumptions factor into the Magic Number, if desired.

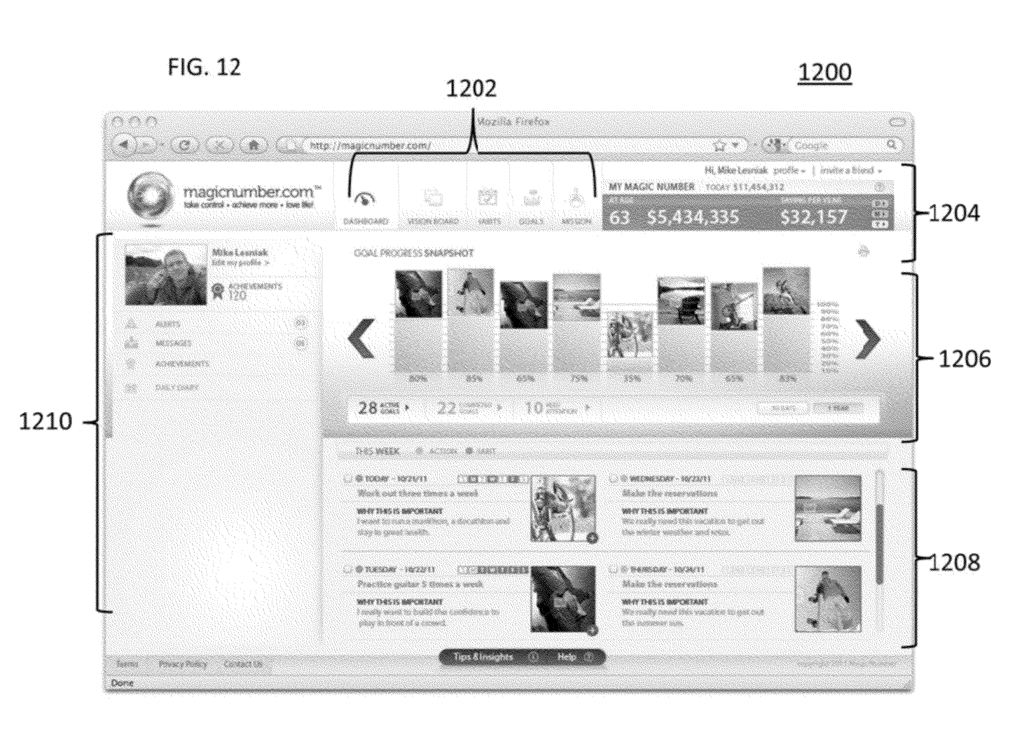

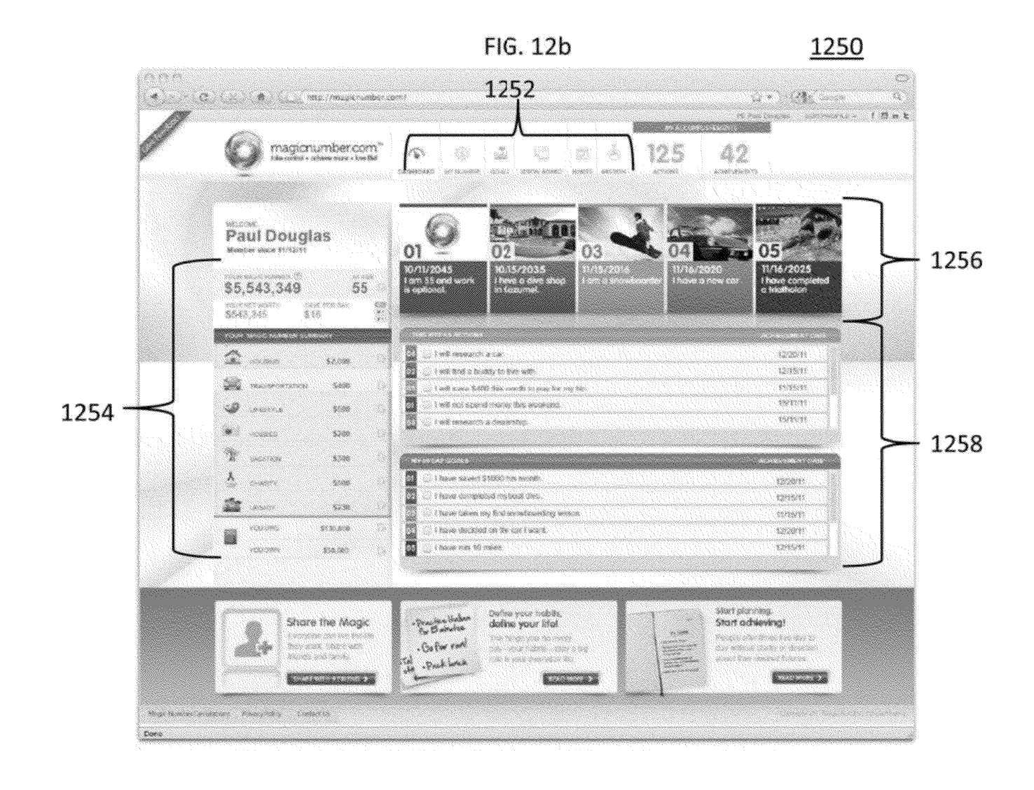

In some embodiments, as illustrated in interface 1200 of FIG. 12, a dashboard can be presented to a user. In some embodiments, the dashboard can be presented after a user is presented with his or her Magic Number, and/or returning users (e.g., users who have registered and discovered their Magic Number) may automatically start at their dashboard when the user return to the site.

As shown, the dashboard can include a dashboard menu 1202, a Magic Number display 1204, a goal progress snapshot 1206, a calendar of events 1208, and a personal status menu 1210.

Dashboard menu 1202 can be used by the user to switch from the dashboard to a vision board, a habits interface, a goals interface, and a mission interface, which are described further below.

Magic Number display 1204 can be used to display the user's Magic Number, Magic Number age (or work-optional age), and wealth improvement required by the user to achieve that Magic Number by that Magic Number age. As shown, “D>”, “M>”, and “Y>” options can be provided to enable the user to switch between viewing the wealth improvement required on a daily basis, a monthly basis, and a yearly basis. The Magic Number may be updated on any suitable basis. For example, as a user's financial situations and lifestyle preferences change, so too may the Magic Number. All other things being constant, the user's Magic Number will change slightly each day as he/she moves closer to the age at which he/she wishes to attain his/her Magic Number.

Goal progress snapshot 1206 can be used to display active goals and progress made against them. As illustrated, these goals can be displayed as bar charts with a bar height that represents a percentage of completion of the goal and an image that corresponds to the goal. In some embodiments, the image can be selected by the user for a particular goal. Using arrows at the left and right side of snapshot 1206, the user can scroll through other goals not immediately displayed. The user can also change the timeline from months to years to show short or long term goals. Snapshot 1206 can also allow the user to select to only display in the snapshot goals to be completed in one or more given time periods (e.g., 90 days or 1 year), and to see the number of, and select for viewing, active goals, completed goals, and goals that need attention.

Calendar of events 1208 can be used by the user to view actions and habits with reminder occurring during the present week. These reminders can be arranged by day.

Personal status menu 1210 can be used to access messages and alerts for overdue actions, habits or goal related activity, the user's record of achievement, the user's profile, and/or any other suitable content.

In some embodiments, any other suitable content can be presented in the dashboard. For example, in some embodiments, assets and liabilities, chosen costs by category, and any other suitable data can be displayed in the dashboard.

In some embodiments, any other suitable links or menu options can be presented in the dashboard. For example, in some embodiments, links or menu options to an “Invite a friend” option, a tips and insights option, additional “What's Really Important” questions, and an Inspiration Lounge can be provided.

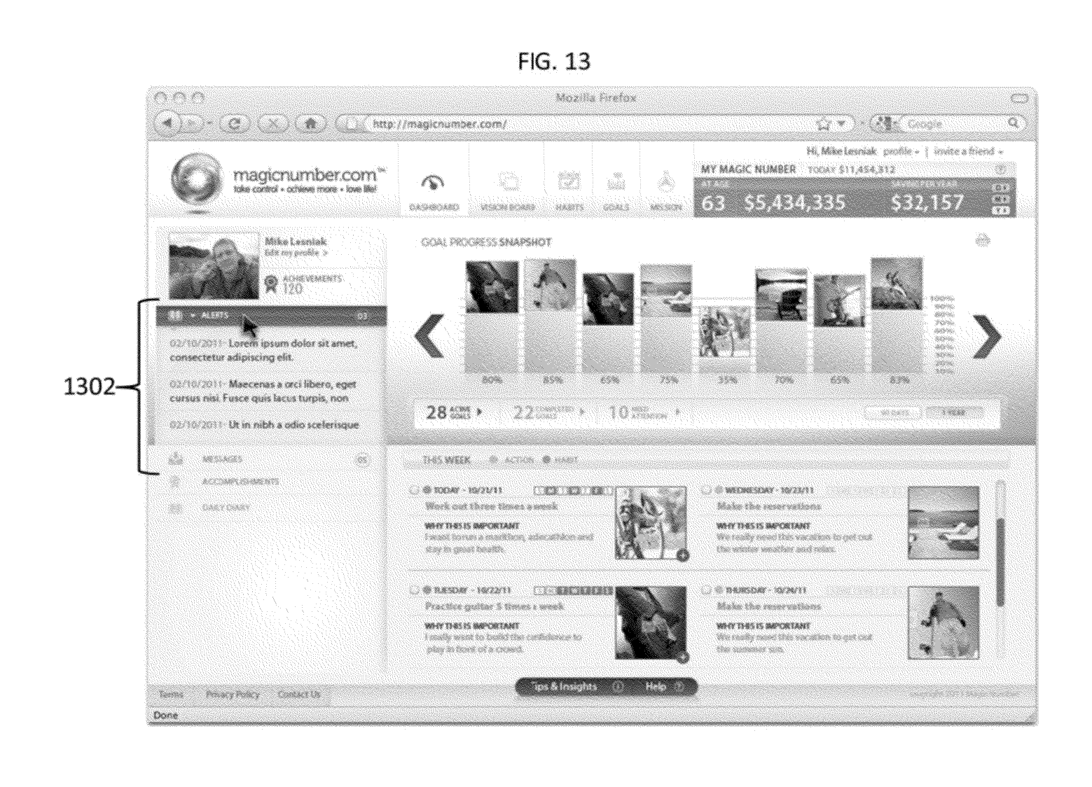

FIG. 13 illustrates an example of an alerts display 1302 that can be presented to a user in user interface 1200 in some embodiments. As shown, the alerts display can be presented in order to display alerts to the user. These alerts can be sorted by time and/or any other suitable factor. In some embodiments, these alerts can be filtered based on any suitable criteria or criterion.

Similarly to the alerts display, in some embodiments, a message display can be provided for displaying messages. Any suitable messages can be displayed, and these messages can be filtered and/or sorted based on any suitable criteria/criterion and/or factors.

For example, in some embodiments, displayed messages can come from a personal avatar, which is a personalized animation that acts as the subscriber's conscience and guide. Such an avatar can prompt a user through such messages, email, short message service (SMS), instant message, and/or any other suitable messaging mechanism. This can be used to help users achieve goals that are set, to provide encouragement and tips on how best to make effective progress with such goals, etc. The user can choose what the avatar looks and sounds like from a range of options.

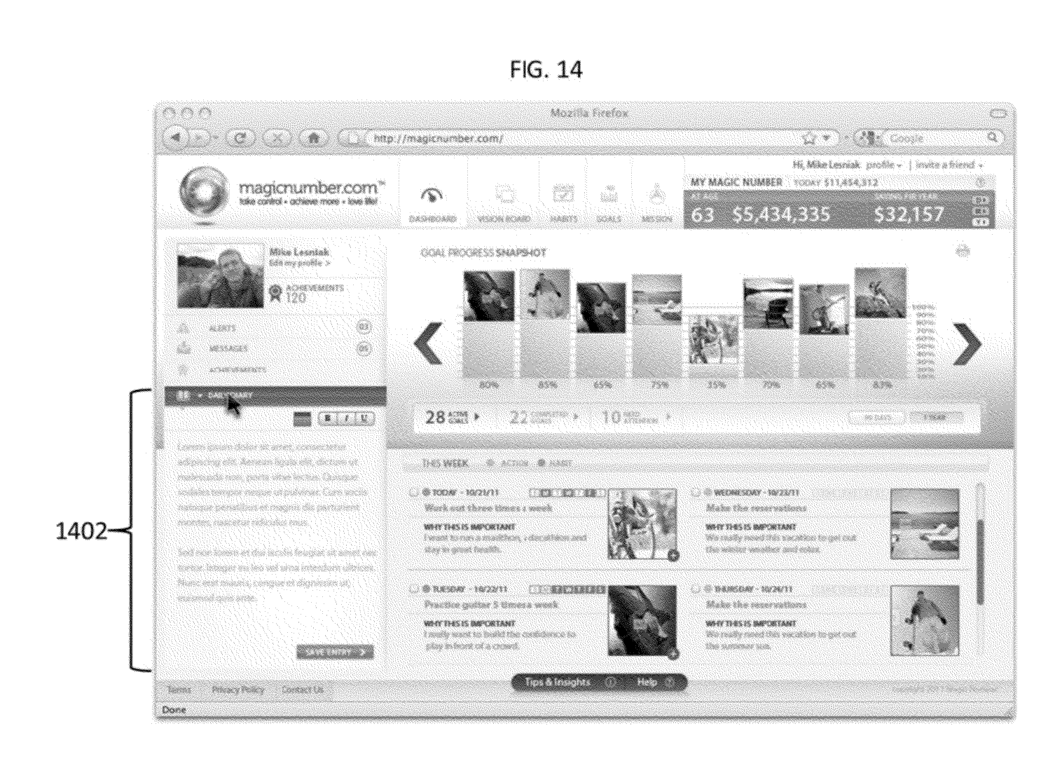

A diary mechanism 1402 as shown in FIG. 14 can additionally or alternatively be provided in some embodiments. As illustrated, this mechanism can be used to enable a user to save diary entries related to his/her Magic Number, goals, habits, alerts, and/or any other suitable subject.

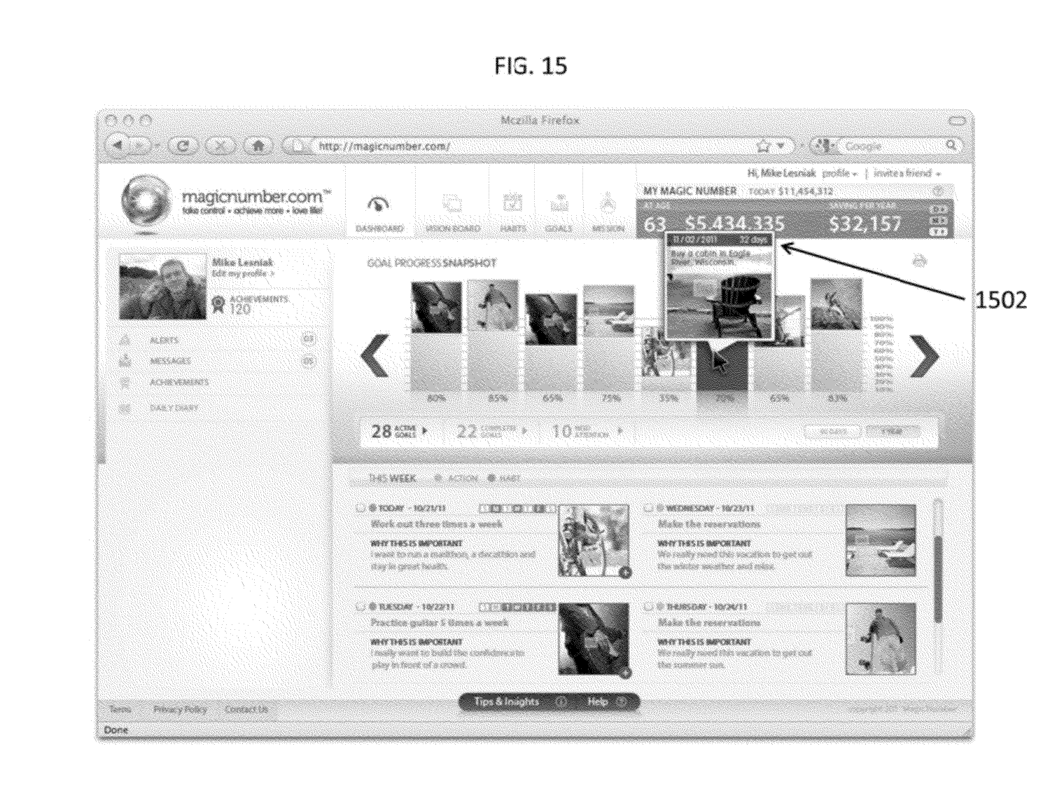

In some embodiments, a user can click on a bar in the goal progress snapshot 1206 and be presented with a goal pop-up 1502 as shown in FIG. 15. As illustrated, this pop-up can present a goal date, an indication of the number of days until the goal, a description of the goal, a picture representative of the goal, and/or any other suitable content.

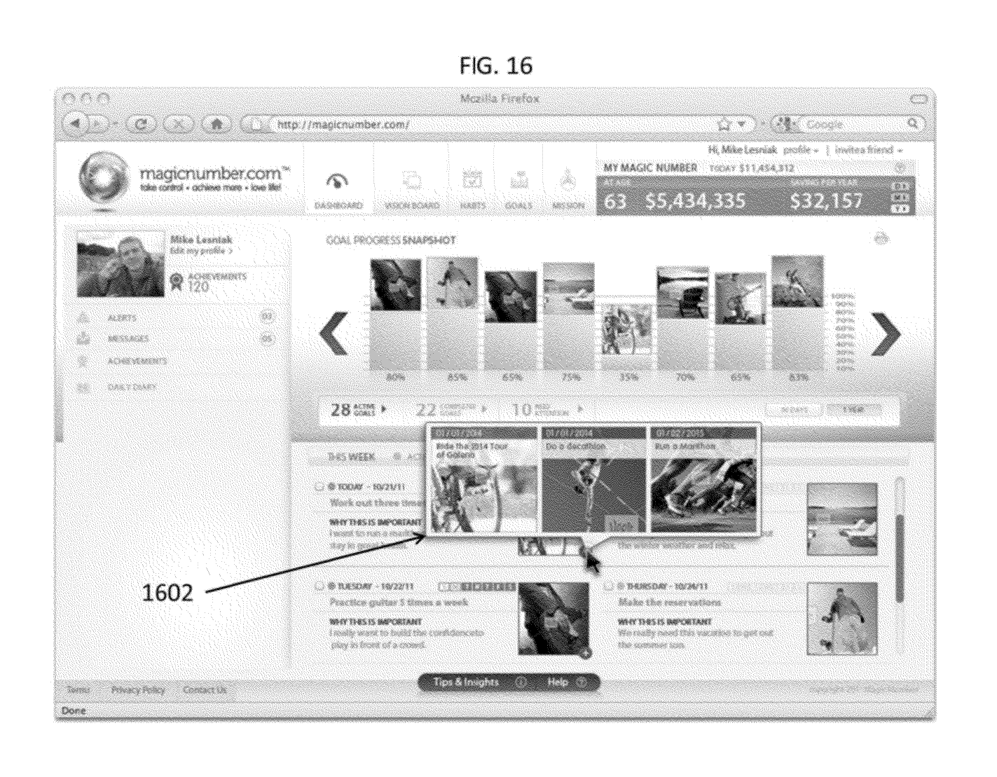

Similarly, when a user clicks on a reminder in calendar of events 1208, the user can be presented with a pop-up display 1602 (FIG. 16) showing one or more images, one or more target dates, and one or more descriptions of goals related to the reminder.

Another example of a dashboard interface 1250 that can additionally or alternatively be used in accordance with some embodiments is shown in FIG. 12b. As illustrated, interface 1250 can include a dashboard menu 1252 that can give the user options to switch to other interfaces. The interface can also include a Magic Number display 1254 that can present the user's Magic Number as well as other information related to the Magic Number as described herein. The interface can further include a goals snapshot 1256 that presents a given number (e.g., five) of the user's goals, and their target dates. The interface can still further include a calendar of events 1258 that can show upcoming activities and goal (or sub-goal) target dates.

Any other suitable dashboard can additionally or alternatively be used in some embodiments.

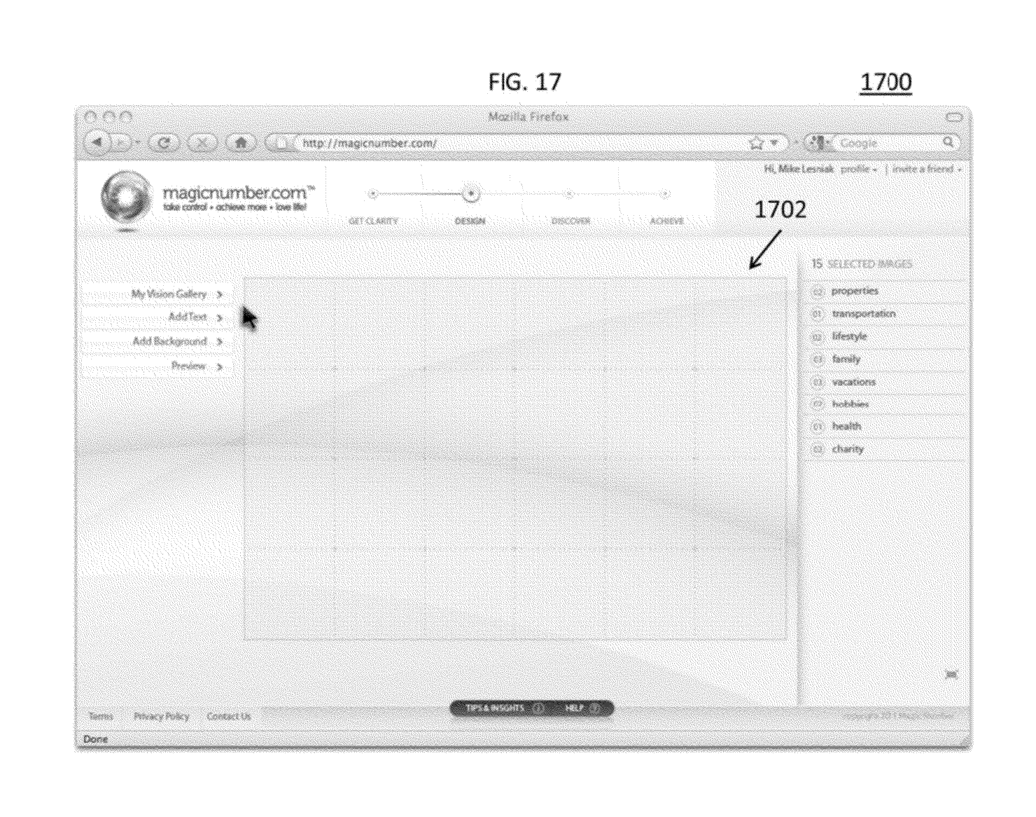

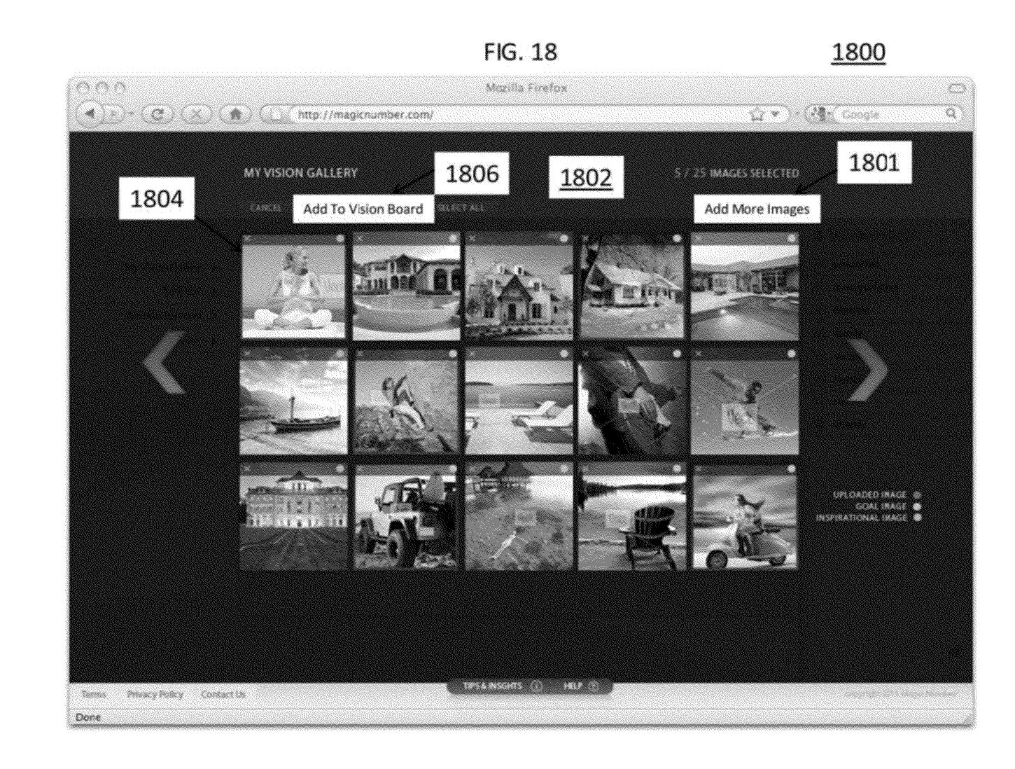

Turning to FIG. 17, an example of a vision board interface 1700 in accordance with some embodiments is shown. As illustrated, interface 1700 can include a vision board 1702 into which the user can assemble visual content to help describe the user's lifestyle, goals, desired habits, and/or any other suitable subject.

As illustrated below, when using vision board 1702, the user can import images from a vision gallery or import their own images and build a visual montage to inspire and motivate them to achieve their goals. A prompt with tips and guidance on how to create a personalized vision board and the benefits of visualisation can be provided in some embodiments.

Upon the user selecting the my-vision-gallery menu option from interface 1700, the user may be presented with a vision gallery 1802 as shown in interface 1800. The vision gallery can be a library of thousands (or any other suitable number) of pictures and images 1804 which can be accessed and searched by category and price range in some embodiments.

In some embodiments, the user can add images to the vision board gallery by clicking on an add-more-images button 1801. Such uploads may be subject to a maximum number of images. In addition, certain “Terms and Conditions” may address issues concerning image quality and resolution as well as any copyright and various other legal aspects.

Once a desired image has been selected, or uploaded and selected, the user can add images to the vision board by clicking on a button 1806. In some embodiments, after an image has been added, the user can be prompted to mark the image either as a goal or an inspiration. If marked as a goal, the image can be added to the goal planner. However, in some embodiments, not all images associated with goals must be displayed on the vision board. The user can select which goals are most important to them and only include those in the vision board, or the user can include images which are not goals, but serve as inspiration.

In some embodiments, images can have cost data associated with them. In some embodiments, cost data associated with an image, whether user-added or not, can be provided by the user, and/or can be obtained from any other suitable source. Some of the images (for example, those of cars) can have data associated with them which can be automatically pulled through to the Magic Number calculation if the user selects them as goals. The data for these images can be supplied by a third party through an API link so that the data associated with them is dynamic so that a user does not have to input costs or other variables.

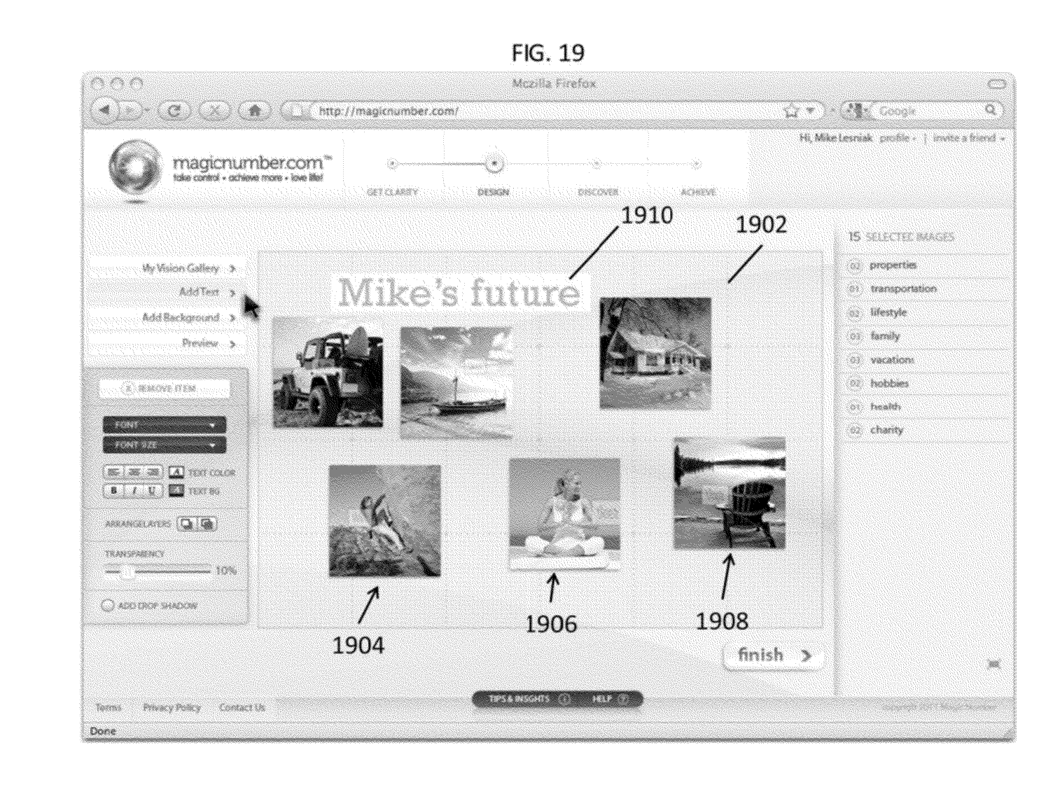

As shown in FIG. 19, in some embodiments, images 1904, 1906, and 1908 selected by a user can be presented in a vision board 1902. In some embodiments, the user can add design elements to such images in the vision board (e.g., greater prominence, size, and/or transparency given to some images than to others). Any suitable number of images may be included in the vision board. For example, the user may choose to have just one large image for the whole vision board or any number of images up to a maximum number of images per vision board (e.g., 20), which may be set in some embodiments.

As also illustrated, the vision board can include text such as text 1910 in some embodiments. Such text can be tailored for font, color, and design.

In some embodiments, vision board images having a time-specific element may be displayed automatically. For example, in some embodiments, the user can set a date to acquire a holiday home and the image of the property will be displayed. The data associated with the image, such as a date of acquisition, price, capital, and running costs, etc., can be displayed by clicking on or moving a cursor over the image. There may also be a progress bar to show how well the user is progressing toward one or more goals that have been set.

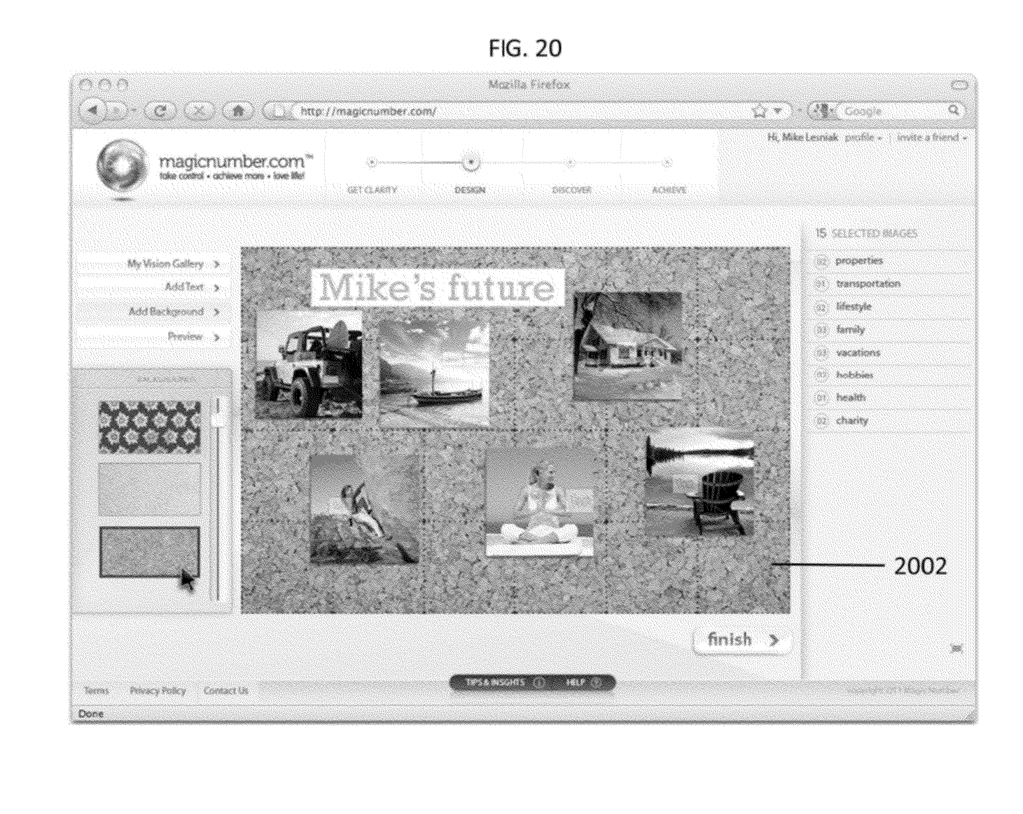

As shown in FIG. 20, in some embodiments, the user can also choose from a wide range of background designs to personalize the vision board further.

Once complete, the vision board may be downloaded as a screensaver (e.g., for a personal computer, Mac, mobile platform, etc.) or printed in a variety of formats. The user's Magic Number can, by default, appear on a user's vision board in some embodiments.

In some embodiments, a “gratitude tablet” may also allow the user to keep a record of what has been achieved to reinforce the positive value of the progress already made over a given time period.

In accordance with some embodiments, a habit tool can be provided. The habit tool can be used to help a user develop good new habits and discard bad ones. A prompt with tips and guidance on setting and acquiring good habits and why this is important can be provided.

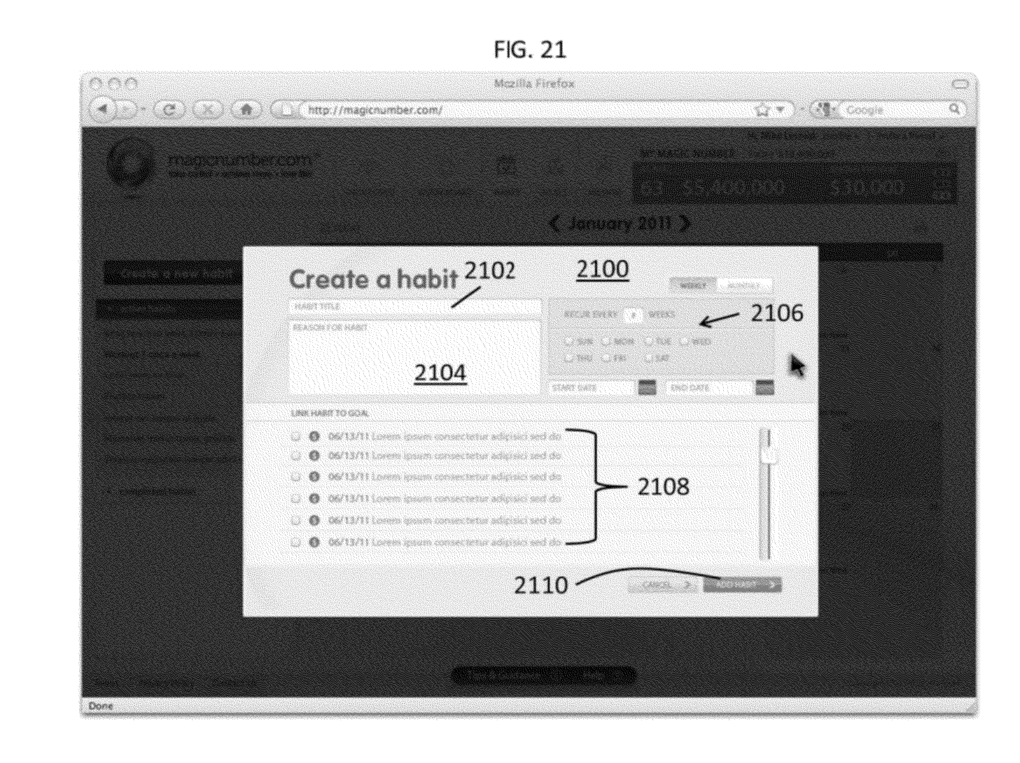

As shown in FIG. 21, a user may set up one or more new habits which can then run over a 21 day cycle (or any other suitable period of time) using a user interface 2100. The user can then define the name of the habit 2102 and why it's important to them 2104 and can also set the frequency of occurrence 2106—daily or other intervals—over the cycle. The habit can also be linked to one or more goals as shown at 2108 in some embodiments. Once configured, the user can save the habit using button 2110.

Each due date, the user can be prompted to check off that the user has completed the action associated with the habit, and this completion can be recorded in to his/her record of achievement. If the user appears to not be adopting the habit, the user can be given help and automated prompts to get him or her back on track.

Habits can also be linked to specific goals—for example, part of a user's 30-day goal timeline might be to acquire a new habit, such as practising the piano once a day for 10 minutes. One habit can be linked to multiple goals if appropriate. For example, taking a 20 minute walk every day might be linked to the two goals of reducing blood pressure and losing weight.

In accordance with some embodiments, the functionality in this area may include automated reminders and encouragement via email and SMS (e.g., based on an opt-in by the user) during the 21 day cycle. The user may select the frequency with which the user is sent such communications.

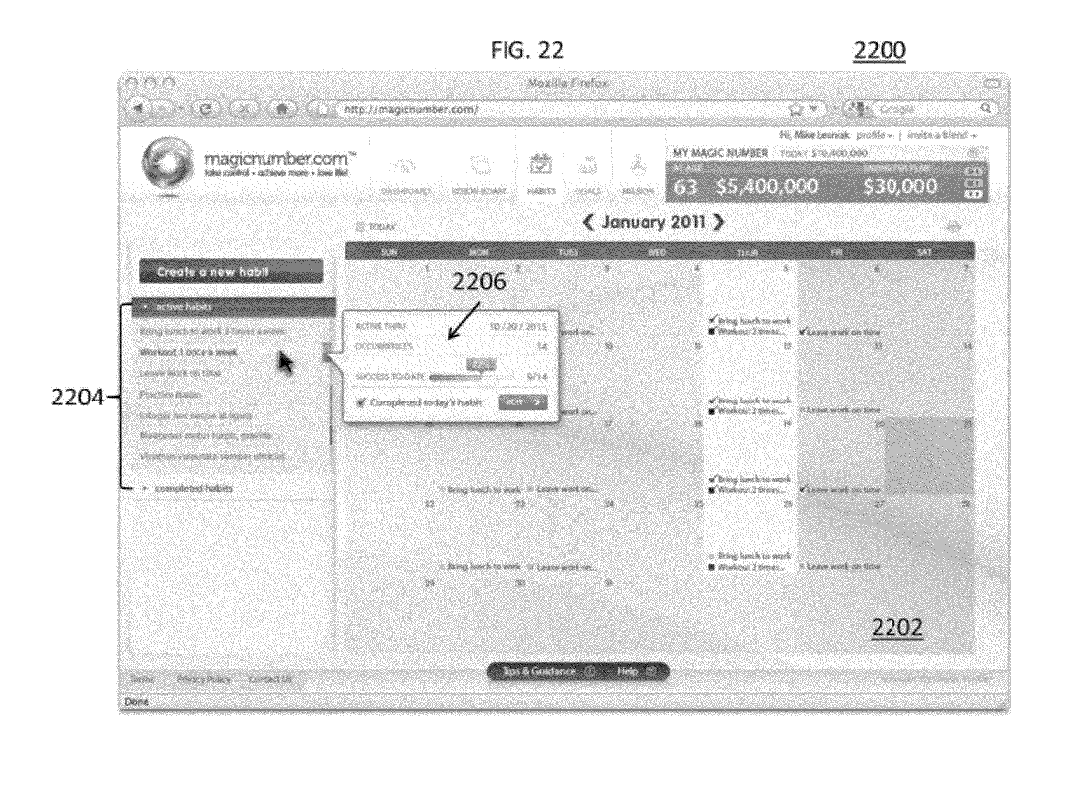

As illustrated in FIG. 22, in some embodiments, a user can be presented with a list of active habits 2204 and a calendar of habits 2202. The calendar of habits can be presented for any suitable time period. Upon selecting a habit in list of habits 2204, a pop-up 2206 can be presented showing the date through which the habit is active, the number of occurrences of the habit that remain, the success rate in performing the habit to date, and whether the habit is complete for today.

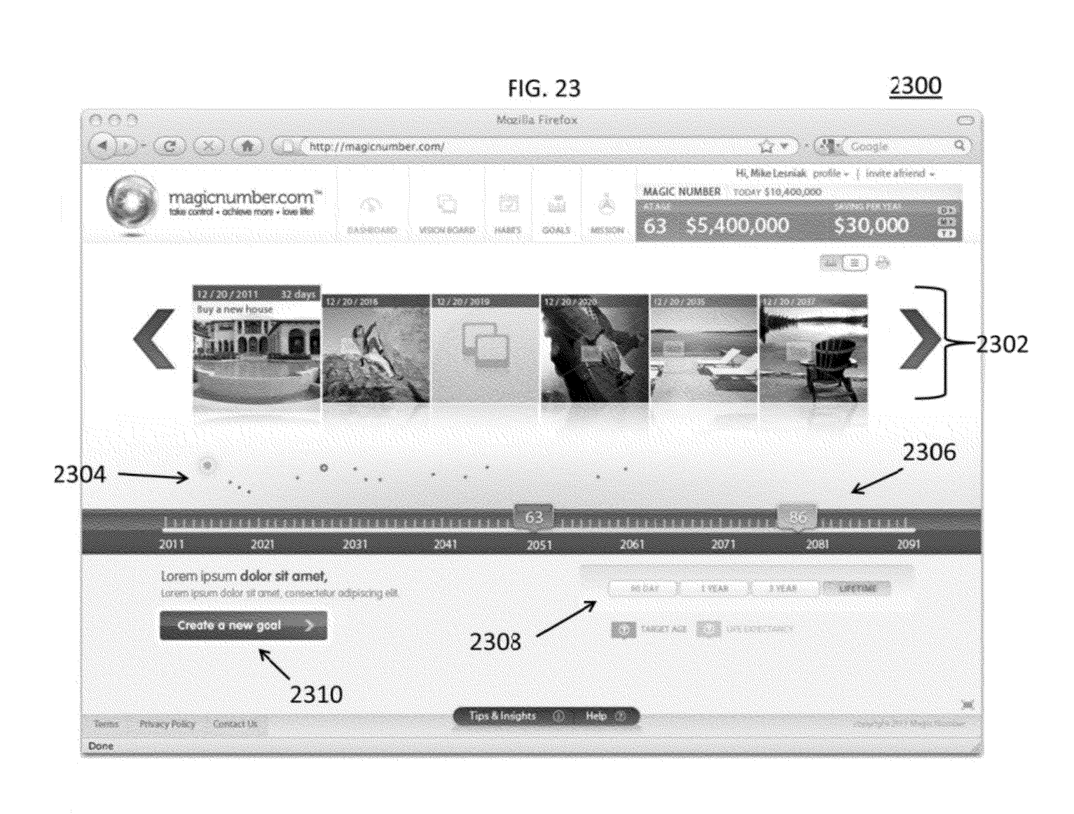

As illustrated in FIGS. 23-27, a goal planner can be presented to a user in some embodiments. The goals planner is an interactive tool which helps users define what the users want to achieve in life over the short, medium and long term and how to do it.

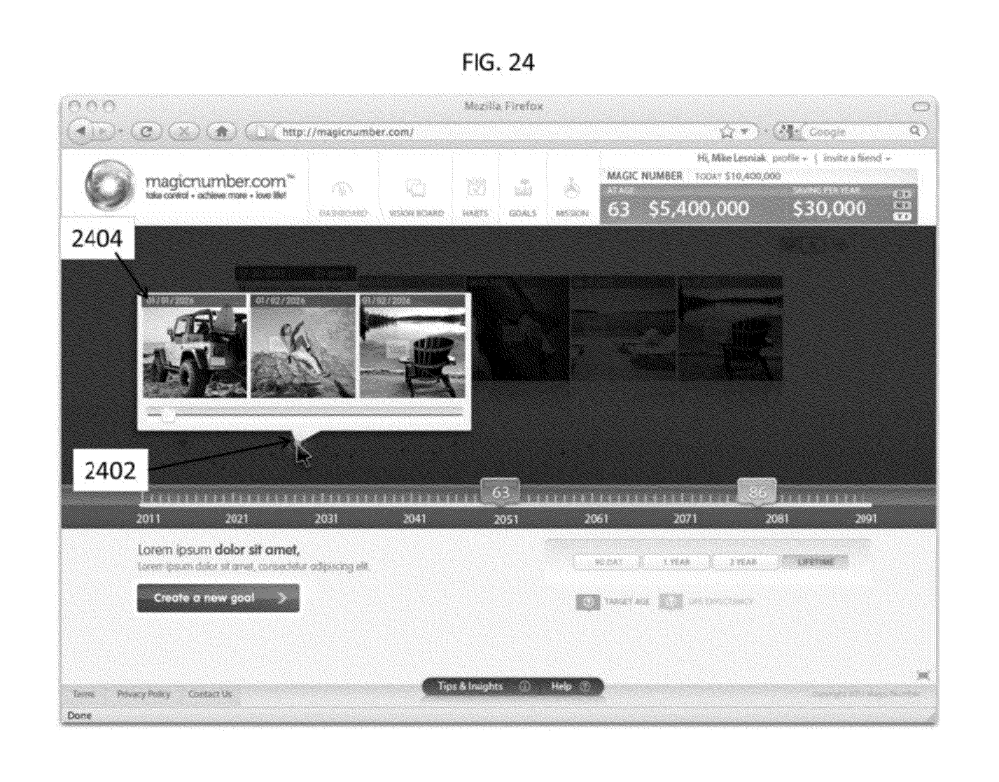

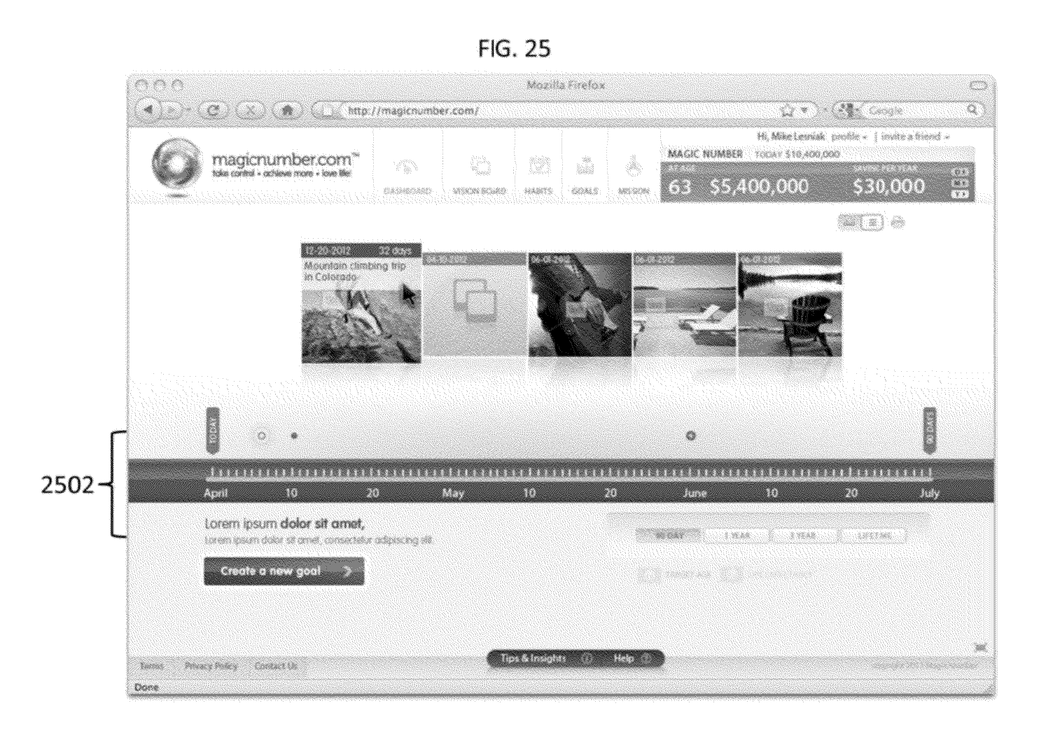

As shown in FIG. 23, when a user activates the goal planner for the first time, an interface such as interface 2300 can be displayed. As shown, this interface can include a timeline which display the user's Magic Number age and life expectancy. At the highest level, goals can be displayed as icons 2304 across the user's whole life span and each icon can be clicked on to view the goal in detail. For example, as shown in FIG. 24, the user can click on a goal 2402 and view images related to that goal in pop-up 2404. The user may change the timeline using buttons 2308 to show one month, three months, one year, three years or lifetime and only the goals which are relevant to that time frame are then displayed as shown in timeline 2502 of FIG. 25. Individual goals can also be displayed as images 2302 across an extended timeline of one month, three months, one year, three years, and lifetime.

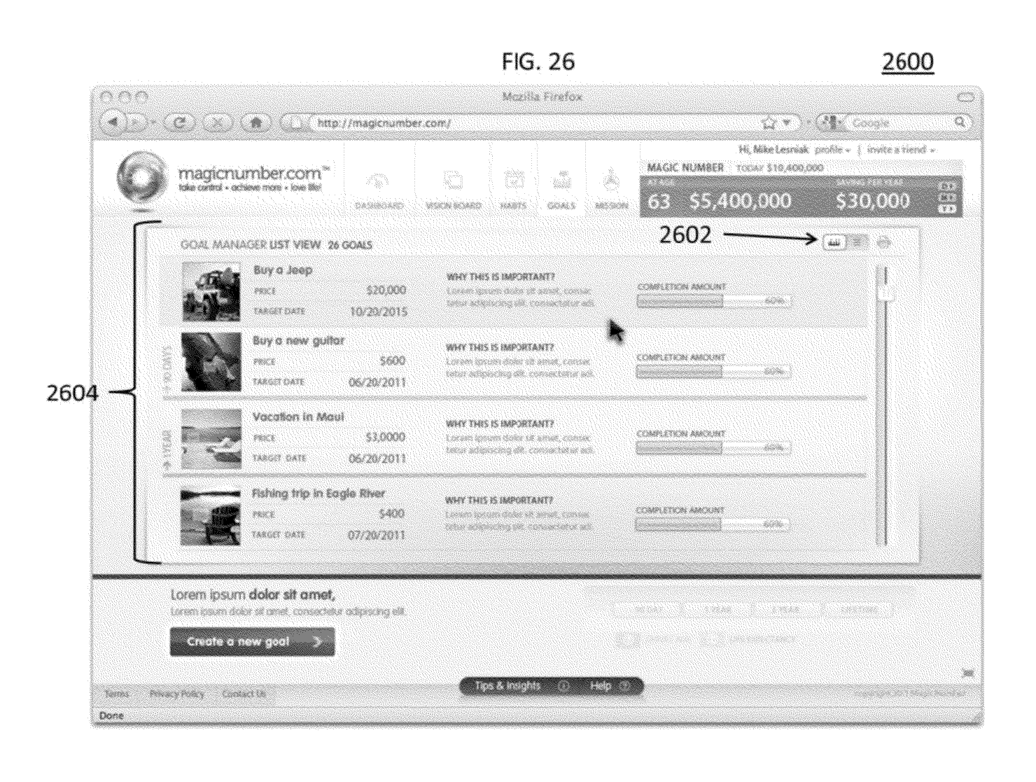

In some embodiments, alternatively to displaying the goals in a timeline format, the goals can be presented in a list 2604 by pressing a list-view button 2602 as shown in interface 2600 of FIG. 26.

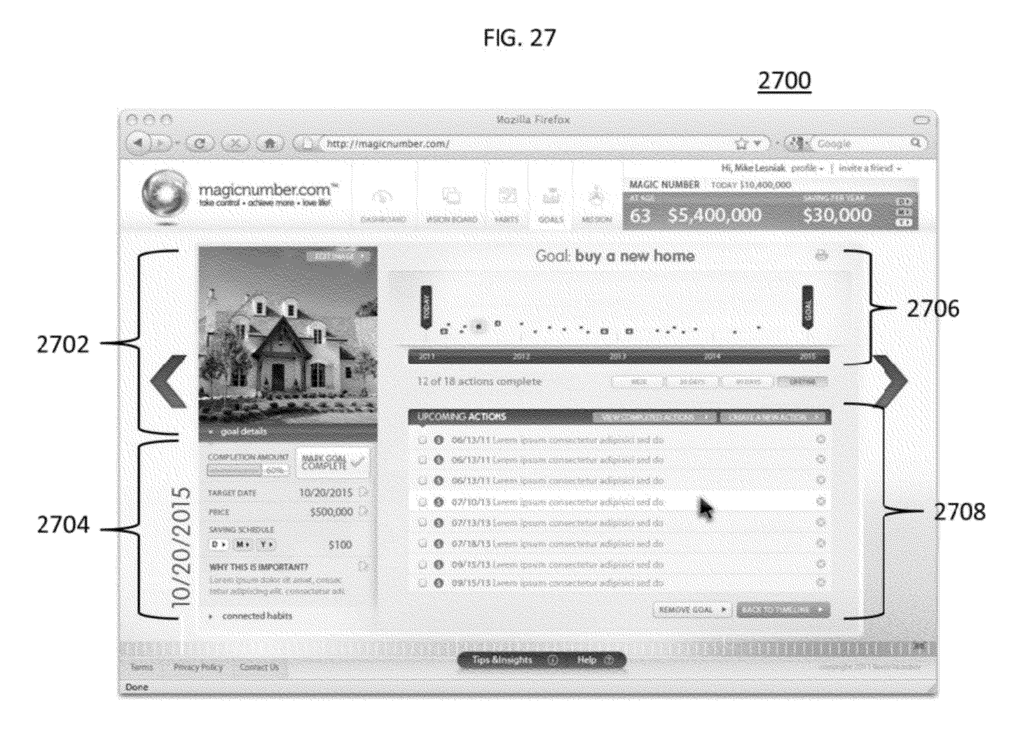

In some embodiments, when a user selects a goal, such as from list 2604, the user can be presented with a list detail display 2700 of FIG. 27. This display shows an image associated with the goal 2702, data for the goal 2704 (such as completion amount, target date, price, saving schedule, and why the goal is important), a timeline 2706 (like the goal timeline described above), and a list of associated tasks 2708.

As shown in list 2708, the goal planner can be used to enable the user to break big goals down into smaller, more achievable tasks which all contribute to achieving a long term objective. For example, if a user wishes to learn to play the piano, the user's three-year goal may be “to have taken and passed my grade 5 piano exam.” The user's one-year goal may then be “to have taken and passed my grade 2 exam.” The user's 90-day goal may become “to have applied for my grade 1 exam” and the user's 30 day goal may be “to have found a piano teacher and to have had 4 lessons.” The goal template allows the user to plan all of their goals in this way. The user may also add tasks and actions to specific goals with due dates. The site automatically prompts the user when these actions or goals are due.

When a user first uses the goal planner, the planner can be pre-populated with visual images that reflect the levels of expenditure the user entered when creating his/her Magic Number. For example, if the user chose a property with a value of $1 million, a house representing that level of expenditure will already be in their goal planner with a target date on the user's Magic Number age birthday. Achieving their Magic Number will also automatically be one of the pre-populated goals.

In some embodiments, the user can add or delete goals. The user can also add images from the Vision Gallery to bring the goal to life. The user may also upload his or her own images to make the goal even more personal. When the user adds an image, the user can choose whether it's for inspiration or is a goal the user wants to achieve. If it's the latter, the user can input specific details relating to the goal—e.g., the cost associated with it, when the user wishes to achieve it, why the user wants to achieve it, and specific short term actions the user needs to perform to make the goal happen. When the user inputs cost data, this feeds into the user's Magic Number calculation and the user receives a message telling them that their Magic Number has changed as a result.

In some embodiments, a prompt with tips and guidance on how to set goals and why the goals are important can also be provided.

Once a task has been accomplished, the user can mark the task as being “Done” and the task can be moved into a list of accomplishments. One or more progress indicators can show how far the user has advanced toward completing his or her goal(s).

In accordance with some embodiments, the user can have the ability to create “mini magic numbers”. These magic numbers can be based around specific individual goals such as buying a new car or clearing certain debt. For example, the car “mini magic number” allows a user to choose an image of the car the user would like to buy from the image library and to see a price the car. The user can input the amount already saved toward the car and the date when the user would like to acquire the car. The “mini magic number” tool can then calculate how much the user would need to save and gives handy hints on how to achieve this mini goal.

In accordance with some embodiments, the user can deselect goals on which the user does not wish to focus. These may include less tangible goals such as learning a new language or instrument.

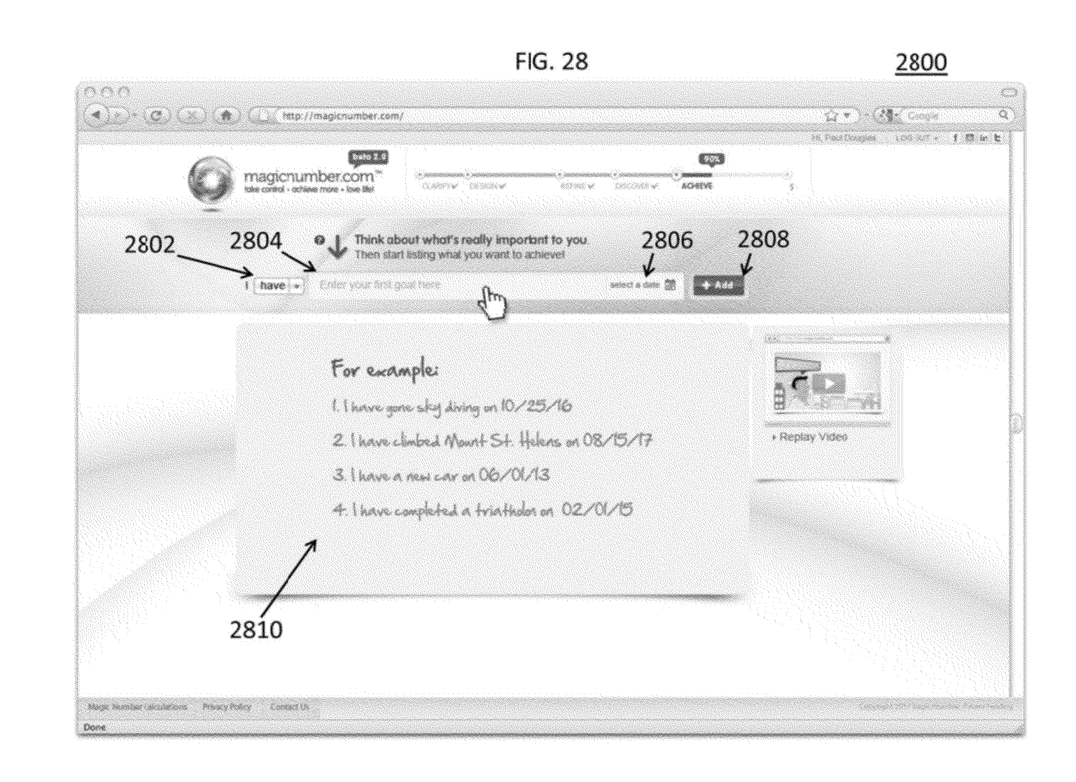

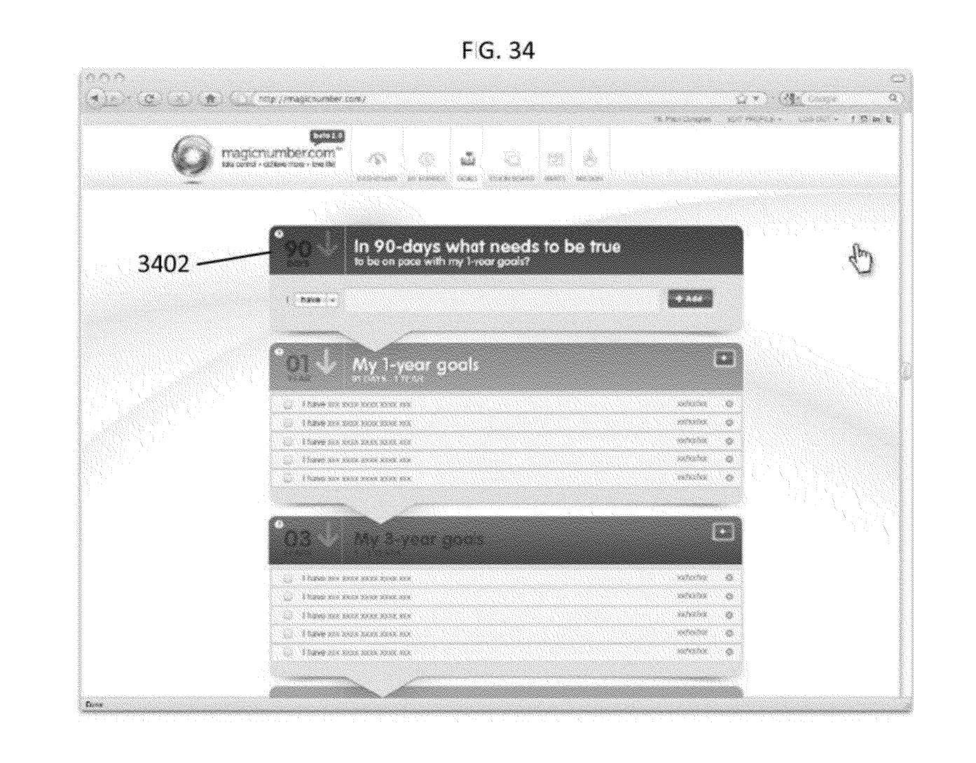

Turning to FIGS. 28-35, other user interfaces that can additionally or alternatively be used to set up goals in accordance with some embodiments are shown.

As illustrated in FIG. 28, for example, a user interface 2800 can be provided that enables a user to enter goals. The user can first select an affirmative statement from drop down menu 2802. Any suitable statement can be included in menu 2802. For example, the affirmative statement can be “I have” or “I am” in some embodiments. Next, the user can enter a goal in box 2804. An example window 2810 can be provided to aid the user in constructing a goal. For example, the goal can be to have a “a dive shop in Cozumel” so that when read with an affirmative statement, the combination of 2802 and 2804 can read “I have a dive shop in Cozumel.” The user can also select a date in field 2806 by which the user hopes to achieve this goal. Then, the user can add the goal to the user's list of goals by pressing add button 2808.

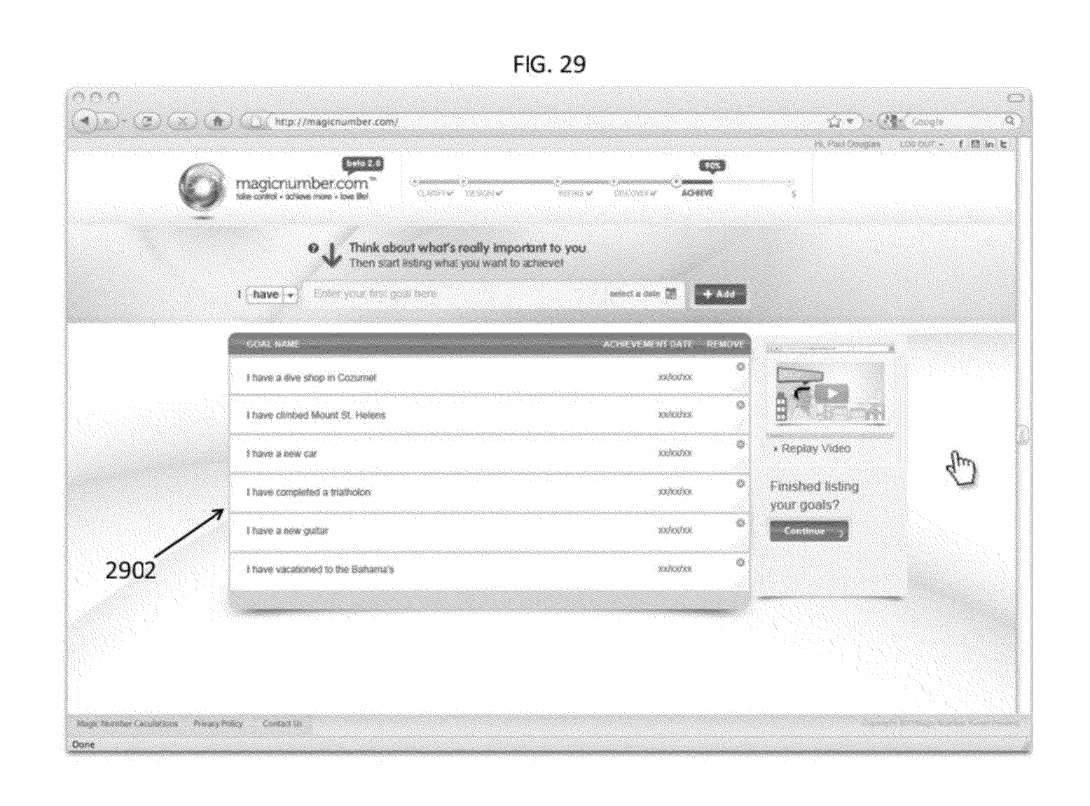

Once the goal has been added, it can appear in a list of goals, such as list 2902 of FIG. 29, in accordance with some embodiments. Thus, for example, the list can now have an entry that reads “I have a dive shop in Cozumel” and show the target date for achieving the goal.

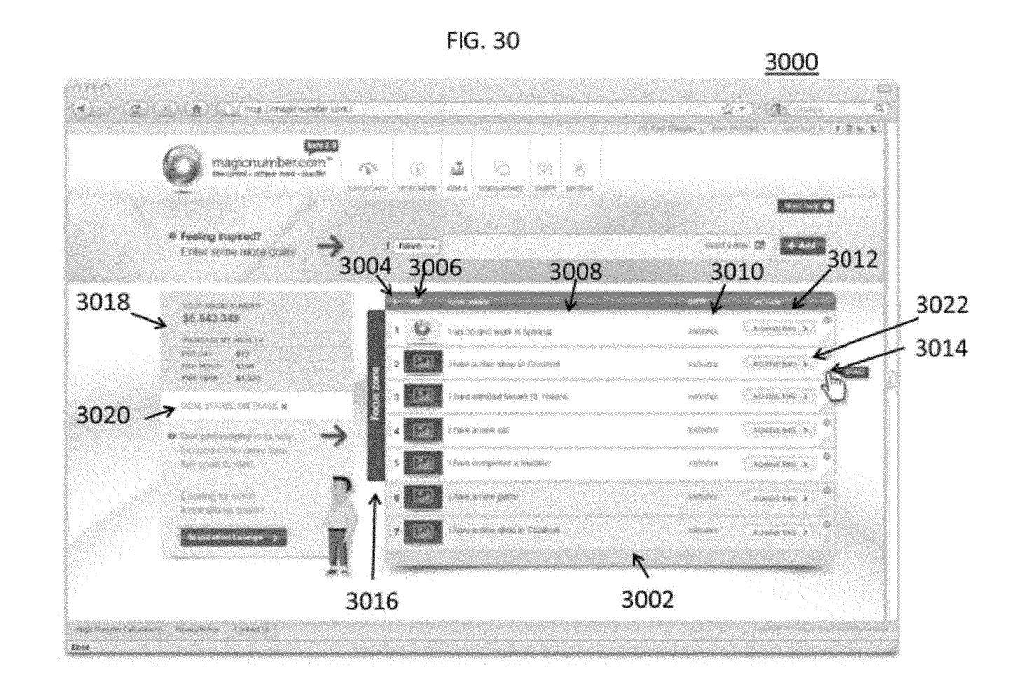

In accordance with some embodiments, goals can additionally or alternatively be presented as shown in interface 3000 of FIG. 30. As illustrated, a list of goals 3002 may be presented which shows goals that the user hopes to achieve. The first goal listed can be achieving the Magic Number in accordance with some embodiments. The goals in list 3002 can be presented along with a goal number 3004, a picture 3006, a name 3008, a target date 3010, an action button 3012, and a drag field 3014. Goal number 3004 can be automatically assigned based on the order in which the goals are entered, and then be modified if and when the user re-orders the goals (e.g., by dragging them by drag field 3014 in list 3002). Picture 3006 can be entered by clicking on an icon presented in list 3002 and selecting a suitable picture from an image library (as described herein), or by adding a picture to a goal created as described elsewhere herein. And, name 3008 and target date 3010 can be selected as described above.

A focus zone 3016 can also be shown in interface 3000. Zone 3016 can be used to identify goals that the user wants to actively pursue. For example, in some embodiments, if a user has configured ten goals, the user may be able to specify five of these goals that are to be actively pursued by the user. In this way, the user's focus can be maintained on a limited number of goals rather than a much higher number. Any suitable number of goals can be focus goals. For example, a limit of five focus goals can be permitted in some embodiments. In order to make a goal a focus goal, the user can drag field 3014 of the goal to focus zone 3016.

As also shown in FIG. 30, area 3018 can display the Magic Number and wealth improvement required per day, month, and year to achieve that goal, and an on-track status indicator 3020 that shows whether the user is on-track to achieve his/her focus goals.

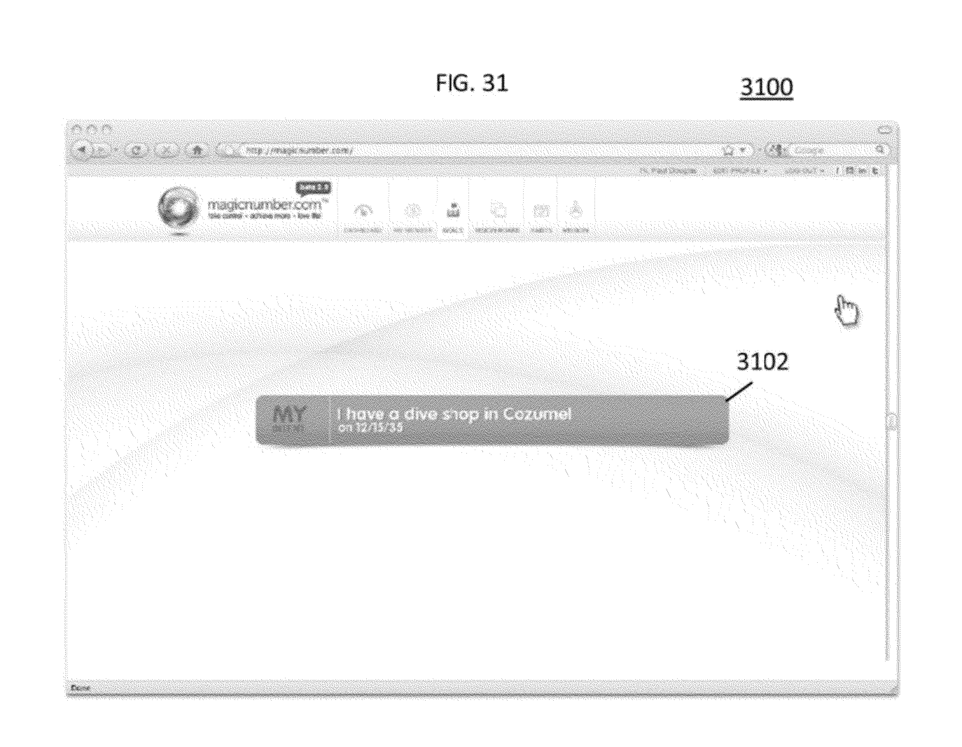

In accordance with some embodiments, upon a user selecting an achieve-this action button 3022, the user can be taken to interface 3100 of FIG. 31. As shown, interface 3100 can include a bar 3102 representing the goal that the user wants to achieve—here, having a dive shop in Cozumel by Dec. 12, 2035.

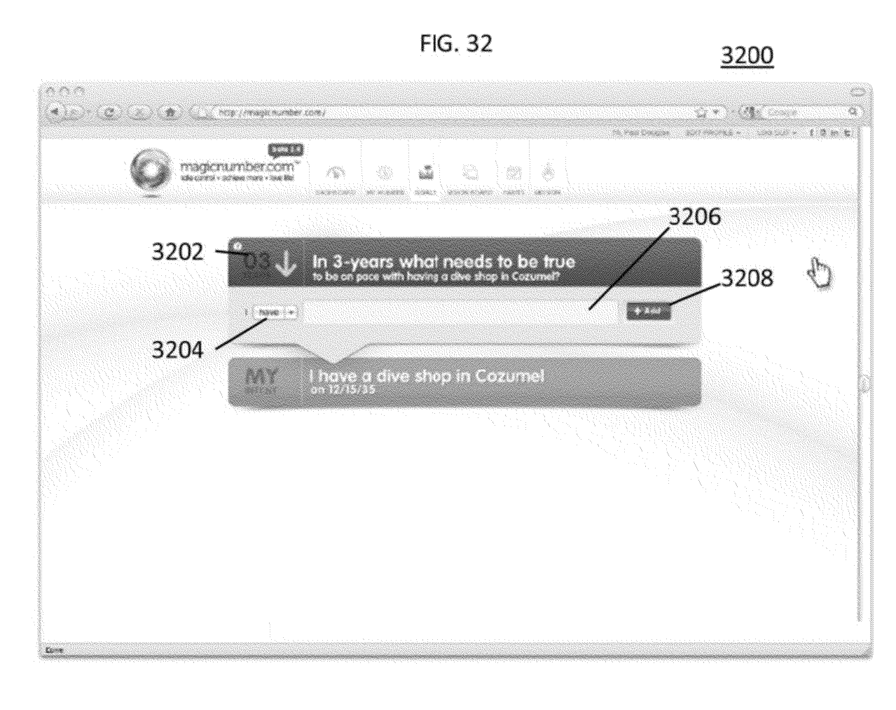

Upon clicking on bar 3102, the user can be presented with a first sub-goal bar 3202 as shown in FIG. 32 that can be used to achieve the goal in bar 3102. As illustrated, sub-goal bar 3202 can enable a user to enter one or more goals using affirmative statement menu 3204, goal field 3206, and add button 3208 similarly to the manner in which the similar mechanisms are used as described above in connection with FIG. 28. Any suitable number of goals can be added to sub-goal bar 3202. The goals listed in sub-goal bar 3202 can all have a target date of a date associated with sub-goal bar 3202. For example, the due date for the goals listed in sub-goal bar 3202 can all have a target date of three years (or any other suitable period of time) from the date on which the user set up the goal shown in bar 3102.

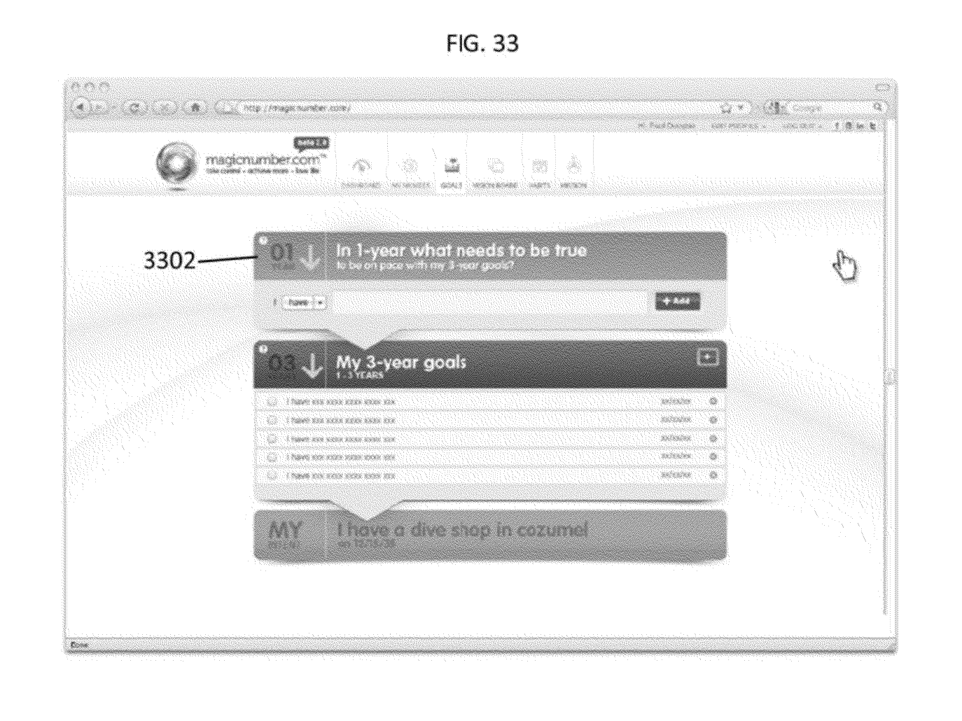

As shown in FIGS. 33-35, the actions described in connection with FIG. 32 can be repeated for other sub-goal periods which can be used to achieve the sub-goals for the encompassing longer periods. For example, using bar 3302, the user can set up one or more sub-goals for one year from the set-up date that can be used to achieve the three year sub-goals. As another example, using bar 3402, the user can set up one or more sub-goals for 90 days from the set-up date that can be used to achieve the one year sub-goals. As yet another example, using bar 3502, the user can set up one or more sub-goals to be achieved immediately to achieve the 90-day sub-goals.

Although specific examples of time periods, and a specific number of sub-goal bars, are shown in FIGS. 32-35, any suitable time periods and any suitable number of sub-goal bars can be provided in accordance with some embodiments.

Reminder messages (e.g., emails, text messages, alerts on the dashboard, etc.) can be provided for any some or all, or none, of the sub-goals configured as described in connection with FIGS. 32-35. For example, reminder messages can be sent out for the 90-day sub-goals.

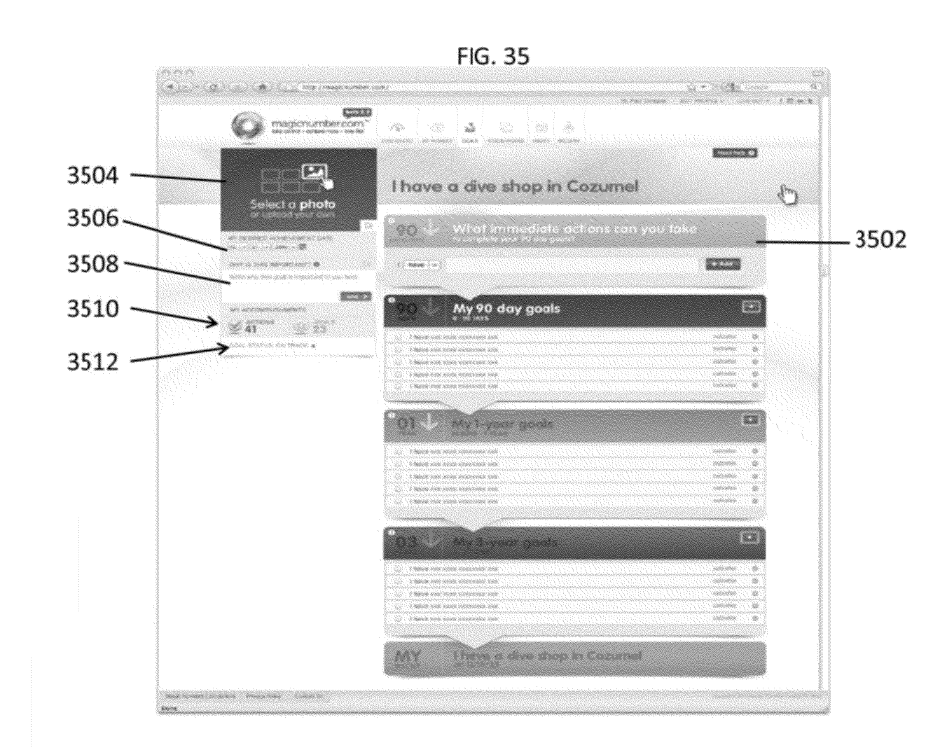

As also shown in FIG. 35, interfaces 3504, 3506, 3508, 3510, and 3512 can be provided to enable a user to select or upload an image (e.g., as described elsewhere herein), to set an achievement date (target date) for the main goal (e.g., having “a dive shop in Cozumel”), to indicate why the goal is important to the user, to show how many total sub-goals are part of this goal and how many have been achieved, and to determine if the status of this main goal is on-track, respectively.

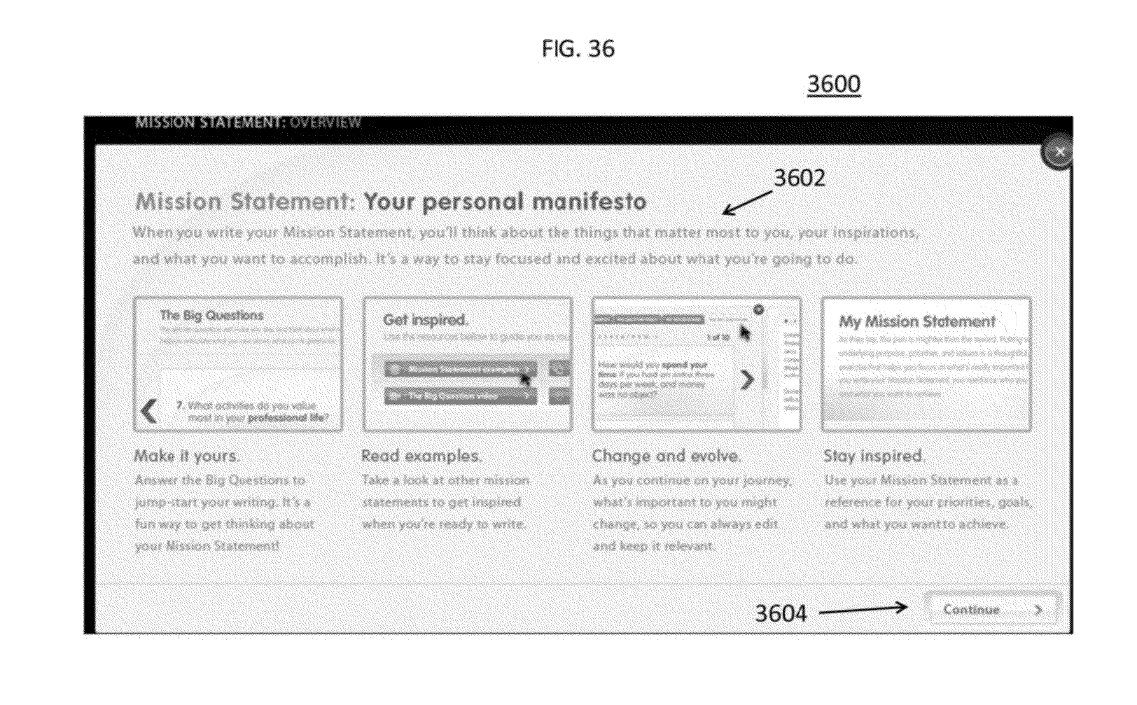

In accordance with some embodiments, a mission statement tool as illustrated in FIGS. 36-38 can be used to set up a mission statement for the user. The mission statement tool can include a template approach that can provide layouts and examples of mission statements to help and inspire people. As shown in interface 3600 of FIG. 36, in some embodiments, a prompt 3602 with tips and guidance on how to create the user's mission statement as well as the benefits it brings can be displayed. Users can also choose from a set of pre-populated personal values or can add their own custom ones and create a set of values to accompany their mission statement in accordance with some embodiments.

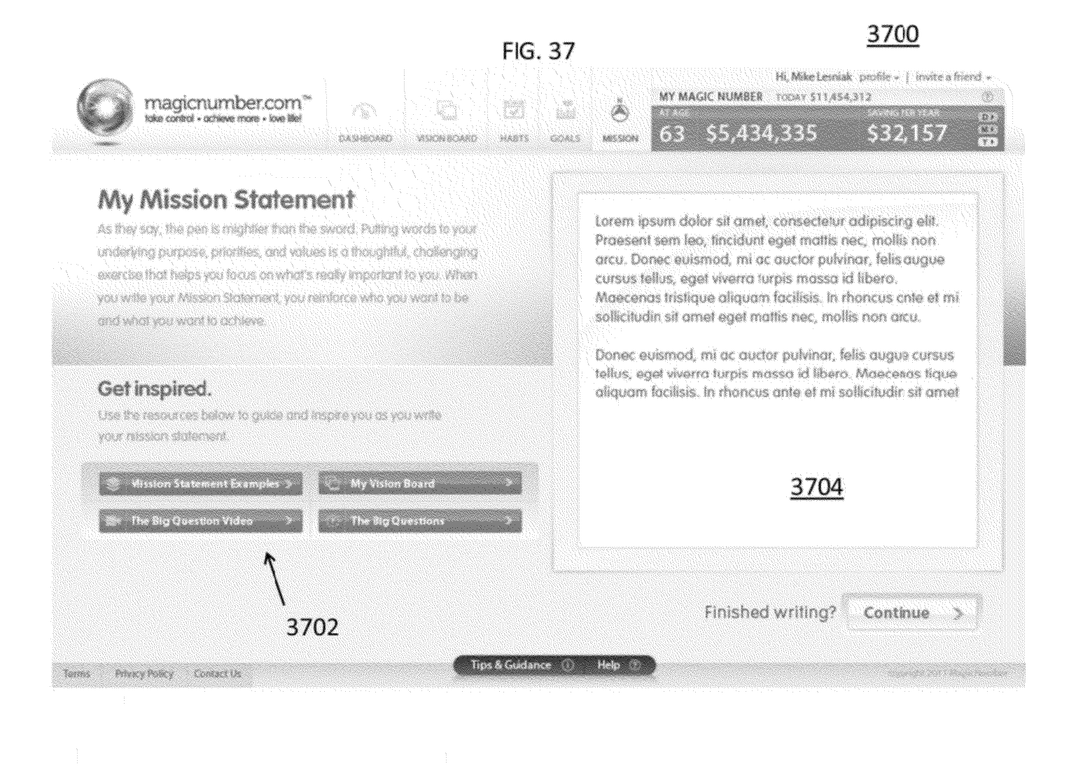

When a user selects a continue button 3604, the user may be taken to an interface 3700 for setting up the mission statement as shown in FIG. 37, in accordance with some embodiments.

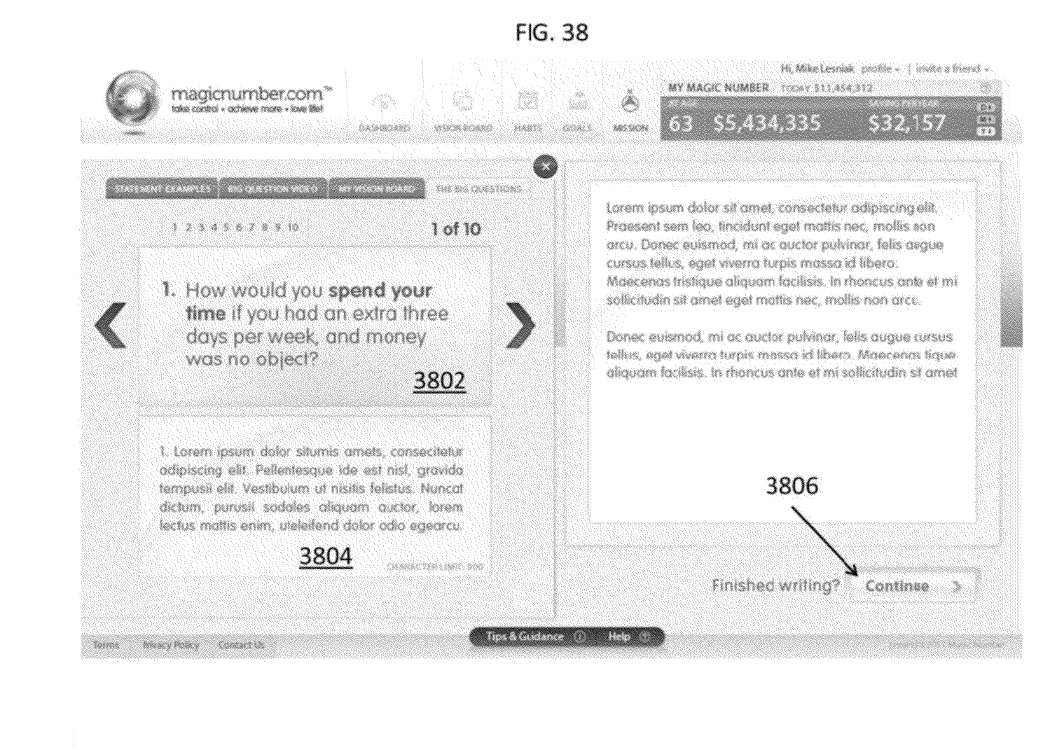

As shown in interface 3700, links 3702 to mission statement examples, to a “Big Question” video, to the user's vision board, and to additional big questions help the user understand and define “What's Really Important” to them. Examples of a big question 3802 and a corresponding answer 3804 are shown in FIG. 38. The content at these links can hopefully provide clarity of purpose and direction to users and encourage them to type in answers to the big questions in the mission statement space. These answers can be merged in the mission statement shown in field 3704 of FIG. 37, and then saved for the user to revisit.

The user can exit the mission statement tool using button 3806.

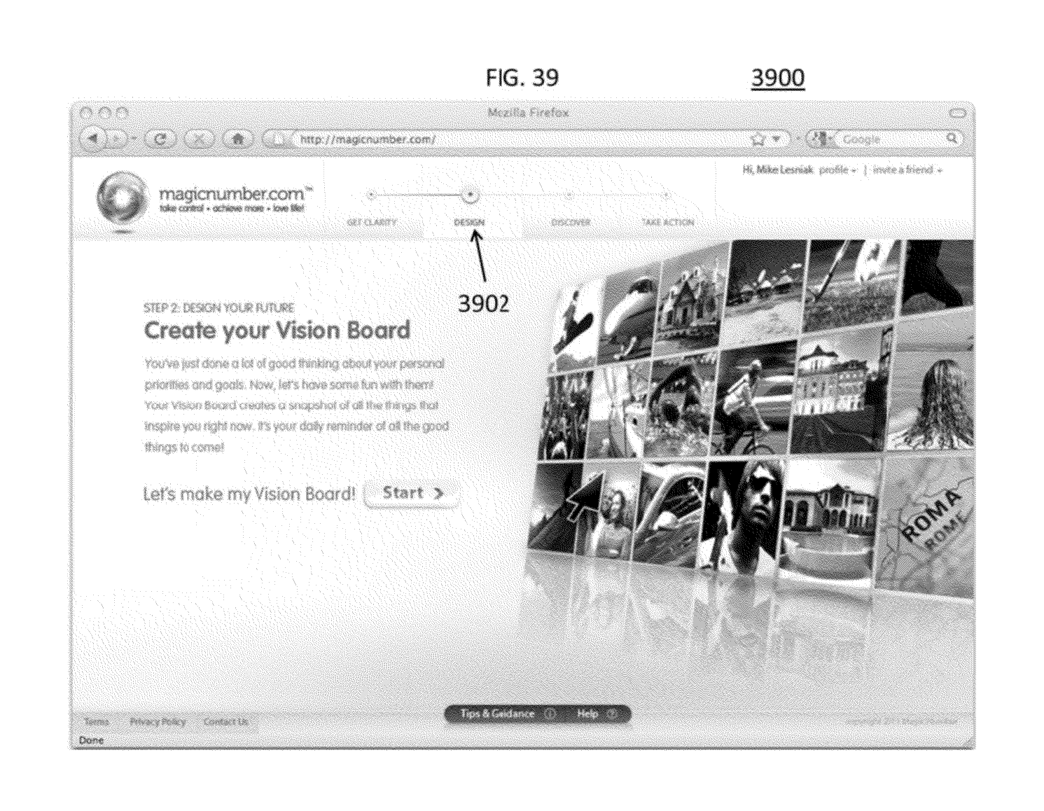

In some embodiments, additionally or alternatively to defining a user's desired lifestyle as described above in connection with FIGS. 2-9, an approach that also creates a vision board can be used as illustrated in FIGS. 39-42.

As shown, an interface like interface 3900 of FIG. 39 can be used to introduce the user to the idea of designing a lifestyle using a vision board. As illustrated, this approach can be used at the design point 3902 of the Magic Number calculation process.

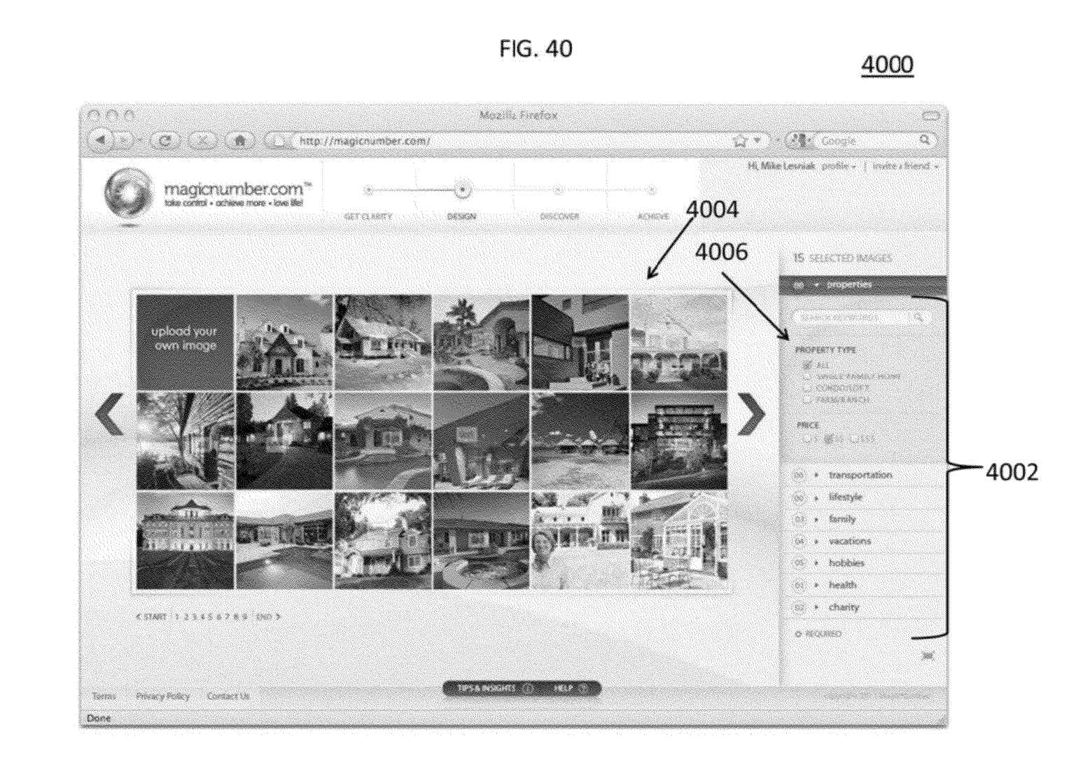

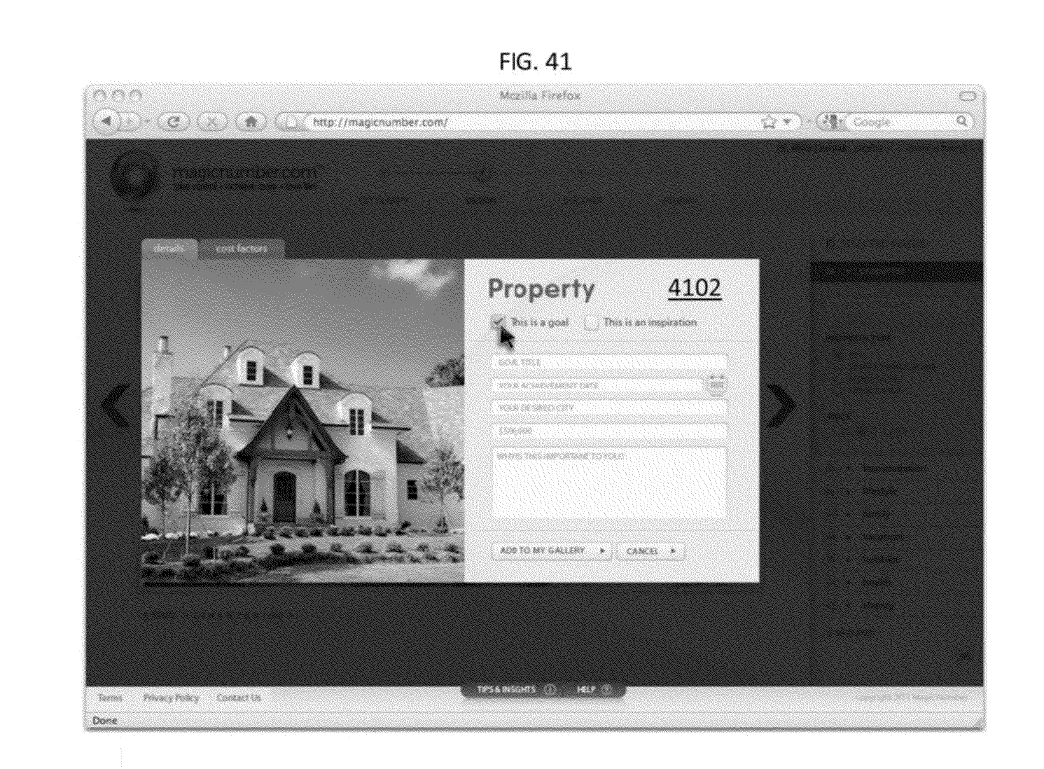

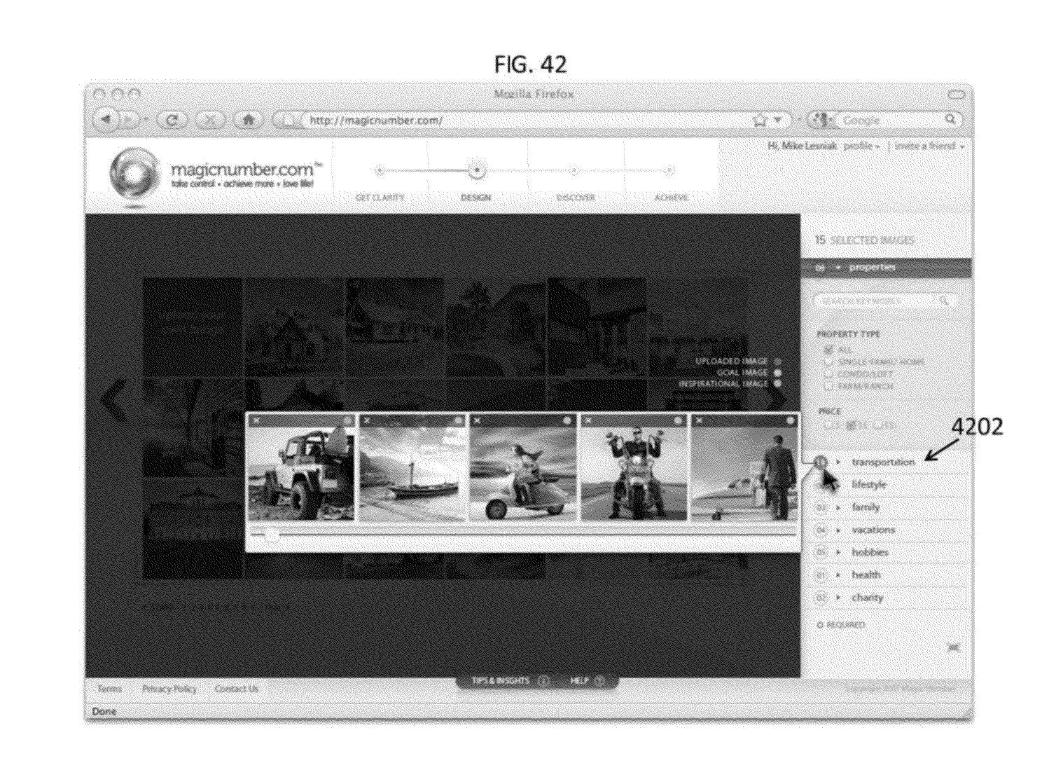

To create the vision board while defining one's lifestyle, the user can use an interface 4000 of FIG. 40. As shown, the user can first select a category to be defined using menu 4002 and make any necessary filtering and/or search selections in area 4006. Next, images 4004 corresponding to the selected category and any filtering and searching can be presented. Upon selecting one of these images, the user may be presented with a window 4102 as shown in FIG. 41 asking for more information such as whether the image corresponds to a goal or an inspiration, and if it is a goal, a title, achievement date, desired city, price, and why it is important. The user can then add the image to the vision board. As shown in FIG. 42, this process can repeat for other categories, such as category 4202, until the user has completed defining his/her lifestyle.

As described above, in some embodiments, each image may have an associated cost, which may be localized for each market (e.g., U.S. dollars and UK sterling). For many categories, these costs may not be visible to the user. There may be exceptions, such as the “Property” category. For “Property,” regional property cost variations may be taken into account. When a user selects a property, a mid-range cost may be displayed (e.g., based on data supplied by expert third parties). The user can have the ability to select this default value or to increase or decrease it based on their personal knowledge of the housing market in the particular region. The user can do so by using a slider or similar tool to move the cost up or down. Once the user is satisfied with the accuracy of the cost, the user can select that cost, which then becomes a factor in the calculation of that user's Magic Number.

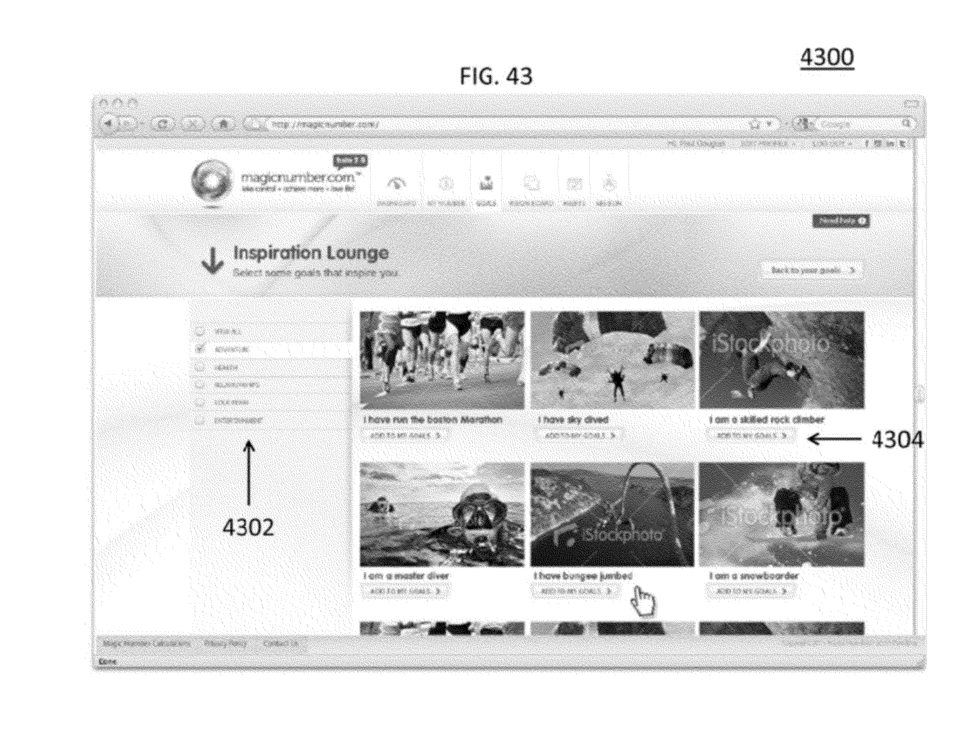

In accordance with some embodiments, an inspiration lounge can be provided. An example of an inspiration lounge is shown in interface 4300 of FIG. 43 in accordance with some embodiments. If a user is struggling to get started with either the vision board, goal planner, mission statement or any other part of the site, the user can visit the inspiration lounge. This lounge can be populated with ideas categorized by themes 4302 and help users to create a list of things that they want to do before they die. By selecting a button 4304, a user can add an inspirational item as a goal. The user can import the ideas or the images associated with the lounge ideas into the user's vision board, vision gallery and goals planner.

In some embodiments, users may be able to interact with each other, encourage each other, post a record of their personal achievements to inspire others, and any other suitable function.

In accordance with some embodiments, a user can be enabled to share his or her Magic Number, goals, and vision board with others. For example, these items can be shared with a group of other users with whom the user shares common goals.

In some embodiments, privacy settings can be provided so that the user only shares as much or as little as the user wants with other Magic Number users. For example, there might be a group who all share the “own a house by the time I'm 30” goal. These users can communicate with each other and share information, encouragement and experiences to help other group members to reach their goals.

In addition, in some embodiments, a user may also share his/her vision board with friends, contacts, etc., via email and social media platforms (e.g., Facebook®, Twitter®).

In some embodiments, users may have the facility to capture their key achievements and lessons. This can be performed in any suitable manner, such as by using a template into which certain key descriptors of achievements and lessons can be recorded. In some embodiments, the user may be able to select from past achievements and goals, and then have the corresponding descriptors automatically populated in the legacy section. The descriptors in these templates can then be published. It can also be shared through the Magic Number community.

In accordance with some embodiments, certain features described herein may only be available to certain users, such as certain subscribers, while others may be available to everyone. For example, in some embodiments, users can be categorized into one of the following categories:

Category 1—Visiting users to the website who have not yet registered or subscribed;
Category 2—Users who have registered but not yet subscribed; and
Category 3—Users who are paying subscribers.

Different functionalities may be provided to a user depending on how the user is categorized. For example, users in category 1 (e.g., unregistered users) may only be allowed to see the homepage (and various introductory information). Registered, but non-paying users (e.g., category 2) may be allowed to use the visualization and Magic Number tools but may not be able to see the Magic Number that is generated specifically for them. Finally, category 3 users (e.g., paying users) may be able to see their Magic Number and adjust the sliders and variables (such as age at which Magic Number is attained) and may have additional access to planning tools. In some embodiments, each category may be allowed access to additional modules (e.g., social media links, community, downloads), though each module may also provide varying levels of details and functionalities based on the user category.

In accordance with some embodiments, subscribers can earn an income from Magic Number. If the user recommends Magic Number to his/her friends and family and some of those people subscribe, the referrer may be paid a percentage of every subscription paid by the new subscriber (e.g., for the first year of subscription only). The site may track referral activity and remunerate subscribers accordingly.

Subscribers also have the option to donate all or part of the money generated to the Magic Number Foundation. This is a charitable body whose purpose is to help improve the lives of those who cannot afford to pay the subscription for Magic Number but who would benefit from its use.

In some embodiments, a user may also be given use of a tool to track and attribute revenue as a result of new subscriptions. The total earned may be shown on the subscribing user's personalized dashboard and can be redeemed either as a credit to a credit or debit card or to purchase goods and services in selected online stores.

In some embodiments, an affiliate program may be operated (e.g., by invitation) whereby selected companies and individuals can achieve affiliate status and promote the Magic Number website and services to their customers. In the event of a customer subscribing, the Refer & Earn payment may then accrue to the affiliate.

In some embodiments, quizzes and polls can be provided to engage users and get their views on a wide range of personal development and other topics.

In some embodiments, access to an online store can be provided.

In some embodiments, users may be able to access third party content—for example, chapter downloads of audio programmes by industry leaders in return for a micro-payment. Selected third parties can provide additional content to complement the user experience. This can include, for example, mini-downloads of an ebook and audio program chapters in return for micro-payments. It may also include offers tailored to specific goals—for example, if a user is planning the vacation of a lifetime to his/her dream destination, a third party travel firm may serve up a tailored offer to meet the specific need.

In some embodiments, the user may be directed to additional help and guidance on how to achieve the Magic Number and other goals that arose as part of the visioning process. The user may receive free hints and tips on achieving goals and how to avoid common pitfalls. The user may also receive hints on how to adapt a desired future lifestyle vision to make it more realistic and achievable. The user may have access to examples of people who have achieved great goals for inspiration purposes.

In some embodiments, users from a particular geographic location may be taken to a localized version of the Web site appropriate to their origin, so, for example, U.S. users can see images and copy that are specific to the U.S. market. Similarly, UK users can see images and copy that are specific to the UK market.

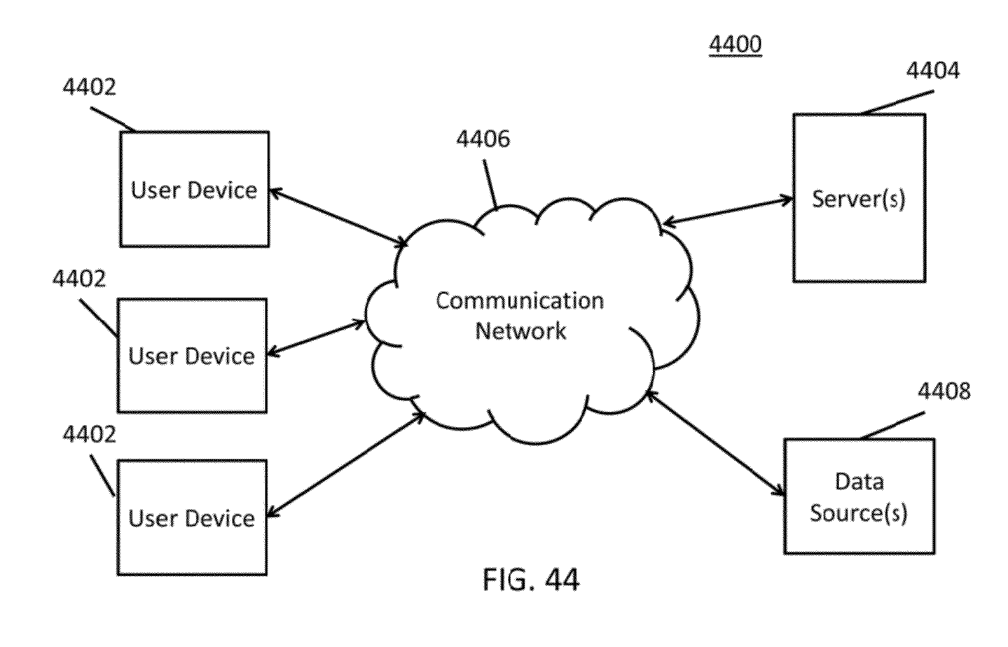

Turning to FIG. 44, an illustration of hardware 4400 that can be used to implement some embodiments is illustrated. As shown, hardware 4400 can include one or more user devices 4402, one or more servers 4404, a communication network 4406, and one or more data sources 4408.

User devices 4402 can be any suitable computing devices such as a general-purpose computer, a special purpose computer, a mobile device such as a cellular phone, smartphone (e.g., such as an iPhone, an Android phone, etc.), a personal digital assistant (PDA), a laptop computer, a desktop computer, a tablet computer (e.g., such as an iPad, etc.), a set-top box, and/or any other suitable computing device. Any of these devices can include any suitable components such as a hardware processor (which can be a microprocessor, digital signal processor, a controller, etc.), memory, communication interfaces, display controllers, input devices, etc. Any of these devices can include an emulator, whether implemented in hardware and/or software. Any suitable number of user devices can be used.

Servers 4404 and/or data sources 4408 can be any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. Any of these devices can include an emulator, whether implemented in hardware and/or software. Any suitable number, including only, of servers can be used.

Communication network 4406 may be any suitable network or combination of any suitable networks. For example, communication network 4406 can include a local area network (LAN), a wide area network (WAN), the Internet, a telephone network, a satellite network, a cable network, and/or any other suitable network or combination of networks.

The mechanisms described herein can be implemented across the devices of hardware 4400 in any suitable manner. For example, the mechanisms described herein can be implemented as a collection of Web pages where in the mechanisms are mainly performed on server(s) 4404 and Web pages corresponding to those mechanisms are presented to one or more users using user devices 4402 via communication network 4406. Data to support some aspects of these mechanisms can be provided by data sources 4408 to servers 4404 and/or users devices 4402. As another example, in some embodiments, the mechanisms can be mainly performed on user devices 4402 as an application or an “app” that communicates with server 4404 and/or data sources 4408 via communication network 4406. Any suitable distribution of the performance of the mechanisms, features, functions, etc. described herein between the user devices, servers, data sources, and/or any other suitable devices not shown can be used in some embodiments.

Various forms of transmission media may be involved in carrying one or more sequences of one or more instructions to a CPU for execution. For example, a bus can be used to carry data to system RAM, from which a CPU can retrieve and execute instructions. The instructions received by system RAM can optionally be stored on a fixed disk either before or after execution by a CPU. Various forms of storage may likewise be implemented as well as the necessary network interfaces and network topologies to implement the same.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims which follow. Features of the disclosed embodiments can be combined and rearranged in various ways.

What is claimed is:

1. A system for lifestyle management comprising:
at least one hardware processor that:
receives a work-optional age selection from a user;
receives a plurality of lifestyle choice settings;
based on the plurality of lifestyle choice settings, presents prompts to the user to make a selection of a desired lifestyle for each of a plurality of lifestyle categories;
receives from the user a plurality of desired lifestyle selections in response to the prompts; and
based on the plurality of desired lifestyle selections, presents a currency amount of assets needed for the user to live a lifestyle consistent with the plurality of desired lifestyle selections for a period of the life of the user.

2. The system of claim 1, wherein the at least one hardware processor also determines a default desired lifestyle selection based on one of the plurality of lifestyle choice settings.

3. The system of claim 1, wherein the at least one hardware processor also causes images corresponding to one of the prompts to change as different desired lifestyle selections are selected in response to the prompt.

4. The system of claim 1, wherein the at least one hardware processor also determines the currency amount based on at least one goal identified by the user.

5. The system of claim 4, wherein the at least one hardware processor also tracks progress of the user toward completing a sub-goal of one of the at least one goal.

6. The system of claim 4, wherein the at least one hardware processor also receives a selection of an image from the user corresponding to one of the at least one goal.

7. The system of claim 4, wherein the hardware processor also receives a selection of a goal from a plurality of default goals as one of the at least one goal.

8. A method for lifestyle management comprising:
receiving, at least one hardware processor, a work-optional age selection from a user;
receiving, at least one hardware processor, a plurality of lifestyle choice settings;
based on the plurality of lifestyle choice settings, causing to be presented, by at least one hardware processor, prompts to the user to make a selection of a desired lifestyle for each of a plurality of lifestyle categories;
receiving, at least one hardware processor, from the user a plurality of desired lifestyle selections in response to the prompts; and
based on the plurality of desired lifestyle selections, causing to be presented, by at least one hardware processor, a currency amount of assets needed for the user to live a lifestyle consistent with the plurality of desired lifestyle selections for a period of the life of the user.

9. The method of claim 8, further comprising determining a default desired lifestyle selection based on one of the plurality of lifestyle choice settings.

10. The method of claim 8, further comprising causing images corresponding to one of the prompts to change as different desired lifestyle selections are selected in response to the prompt.

11. The method of claim 8, further comprising determining the currency amount based on at least one goal identified by the user.

12. The method of claim 11, further comprising tracking progress of the user toward completing a sub-goal of one of the at least one goal.

13. The method of claim 11, further comprising receiving a selection of an image from the user corresponding to one of the at least one goal.

14. The method of claim 11, further comprising receiving a selection of a goal from a plurality of default goals as one of the at least one goal.

15. A non-transitory computer-readable medium containing computer-executable instructions that, when executed by a processor, cause the processor to perform a method for lifestyle management, the method comprising:
receiving, at least one hardware processor, a work-optional age selection from a user;
receiving, at least one hardware processor, a plurality of lifestyle choice settings;
based on the plurality of lifestyle choice settings, causing to be presented, by at least one hardware processor, prompts to the user to make a selection of a desired lifestyle for each of a plurality of lifestyle categories;
receiving, at least one hardware processor, from the user a plurality of desired lifestyle selections in response to the prompts; and
based on the plurality of desired lifestyle selections, causing to be presented, by at least one hardware processor, a currency amount of assets needed for the user to live a lifestyle consistent with the plurality of desired lifestyle selections for a period of the life of the user.

16. The non-transitory computer readable medium of claim 15, the method further comprising determining a default desired lifestyle selection based on one of the plurality of lifestyle choice settings.

17. The non-transitory computer readable medium of claim 15, the method further comprising causing images corresponding to one of the prompts to change as different desired lifestyle selections are selected in response to the prompt.

18. The non-transitory computer readable medium of claim 15, the method further comprising determining the currency amount based on at least one goal identified by the user.

19. The non-transitory computer readable medium of claim 18, the method further comprising tracking progress of the user toward completing a sub-goal one of the at least one goal.

20. The non-transitory computer readable medium of claim 18, the method further comprising receiving a selection of an image from the user corresponding to one of the at least one goal.

21. The non-transitory computer readable medium of claim 18, the method further comprising receiving a selection of a goal from a plurality of default goals as one of the at least one goal.
